(19) United States
(12) Patent Application Publication
(10) Pub. No.: US 2009/0114828 A1
(43) Pub. Date: May 7, 2009

(54) RADIATION MONITORING DEVICE AND METHODS OF USE

(76) Inventors: David L. Decker, Reno, NV (US); Thomas G. Carnahan, Sparks, NV (US); James E. Murphy, Verdi, NV (US); Brad F. Lyles, Reno, NV (US)

Correspondence Address: Board of Regents, Nevada System of Higher;Education, on Behalf of Universtiy of Nevada, Reno, UNR-DRI Technology Transfer Office, Mail stop 0321, 1664 N. Virginia St, Reno, NV, 89557, US

(21) Appl. No.: 12/299,963

(22) PCT Filed: May 10, 2007
(86) PCT No.: PCT/US07/68711

§ 371 Date: Nov. 7, 2008

Related U.S. Application Data
(60) Provisional application No. 60/799,525, filed on May 10, 2006.

(51) Int. Cl. G01T 1/20

(52) U.S. Cl. 250/364; 250/362

(57) ABSTRACT

In some embodiments, the present disclosure provides a monitoring device that is capable of autonomously measuring in situ radiation activity in the subsurface, such as tritium activity. In particular embodiments, the device includes a water decomposition reactor which decomposes an aqueous sample, such as a reactor which includes a reactive metal alloy, such as NaK. In further embodiments, the device includes a detector and a hydrogen getter. The hydrogen getter removes hydrogen and tritium gas from the detector, allowing multiple measurements to be made without removal or servicing of the device. The present disclosure also provides instruments having detector and reactor portions separated by an isolation valve. Particular embodiments of the device include a high pressure valve, such as a rotary valve, for selectively placing the device in communication with a sample source, such as liquid in a well.

### CROSS REFERENCE TO RELATED APPLICATION

This application claims the benefit of, and incorporates by reference, U.S. Provisional Patent Application No. 60/799,525, filed May 10, 2006.

### FIELD

The present disclosure relates to apparatus and methods for detecting radioactive substances. In particular embodiments, down hole tritium monitoring devices are provided.

### BACKGROUND

Many underground nuclear tests, such as those conducted at the Nevada Test Site (NTS), were detonated over 1,000 ft (305 m) below ground, many conducted at or below the groundwater table. These tests injected various radionuclides, including tritium, into the groundwater. Groundwater wells have been drilled at and near the NTS to sample the groundwater for radionuclides. The wide range of half-lives of the radionuclides of concern means that subsurface monitoring for some of these constituents will occur for the foreseeable future. Some of these radionuclides and their associated half-lives are: ³H (12.3 yrs), ⁹⁰Sr (28.8 yrs), ¹³⁷Cs (30.1 yrs), and ²³⁸U (4.47E+9 yrs).

While tritium has a relatively short half-life, tritium is of interest because of its groundwater transport characteristics. Tritium generally does not react with rock and mineral surfaces of an aquifer during groundwater transport. As a consequence, tritium typically moves at the average groundwater velocity and usually is transported ahead of other reactive radionuclides. Accordingly, tritium arrival in a monitoring well can be an indicator of subsequent arrival of other radionuclides.

Current sampling procedures for tritium typically include the installation of a pump in a monitoring well, usually removal of at least three well volumes of fluid. Such procedures typically require specific fluid management protocols, collection of a sample, removal of the pump and pump string, and the decontamination of these components. The U.S. Department of Energy (DOE) has estimated that sampling 200 monitor wells for 100 years using current practices would cost over $150 million in present-day dollars.

Tritium emits a low-energy β-particle (18.6 KeV). Current typical tritium analysis systems are based on liquid scintillation, where a water sample is collected and mixed with a “cocktail” of organic compounds that emit light when struck by the tritium β-particle. A photomultiplier tube that amplifies the signal sufficiently to provide an accurate electronic representation of the tritium activity.

Dissolved radioactive ions such as ¹⁴C (156.5 KeV), ⁴⁰K (1,460 KeV), ²²⁶Rn (6,000 KeV), and ²³⁸U (4,196 KeV) are nearly always present in groundwater. The presence of these ions raises the background radiation level and can negatively impact the detection limit of liquid scintillation detectors. Consequently, water must typically be purified to reduce the concentration of these ions to a sufficiently low level.

### SUMMARY

The present disclosure provides apparatus and methods for detecting the presence, and measuring the quantity, of radioactive materials, such as tritium. In particular embodiments, the present disclosure provides such monitoring apparatus that are capable of making repeated measurements within a down hole environment without transfer of material from the instrument, such as to outside of the down hole environment, or removal of the instrument. The instrument, in particular examples, is remotely operable or autonomous, requiring no user interaction for monitoring.

In the various disclosed embodiments, the components of the monitoring apparatus are arranged to facilitate deployment in a down hole environment. Certain implementations include a controller on the instrument, while the controller is remote from, but in communication with, the instrument in further implementations. The controller, in particular examples, is in communication with a remote computer or remote computer system, such as a surface computer. In further implementations, the instrument is supplied with power using surface-located solar panels and, optionally, a deep cycle battery, such as a battery located on the instrument.

In a particular embodiment, the present disclosure provides a radiation monitoring apparatus which includes a detector and a sample decomposition reactor. The sample decomposition reactor includes a quantity of a reactive metal alloy. In particular examples the reactive metal alloy is NaK. In some implementations, the decomposition reactor includes a liquid injection nozzle and an active metal alloy into which an aqueous sample is injected. In further implementations, the decomposition reactor includes a baffle structure to help prevent reaction products of the sample and reactive metal alloy from entering a gas outlet of the decomposition reactor. The reactive metal alloy, in specific examples, is introduced into the decomposition reactor through a standpipe.

Particular configurations of apparatus of this embodiment of the present disclosure include a detector that measures radiation present in a gaseous sample. For example, the detector may be a proportional detector or a gas scintillation detector. The detector, in a specific example, is a proportional detector having an organic quench gas, such as propane or methane.

The present disclosure also provides a monitoring apparatus having a proportional detector. The proportional detector includes a central hollow support rod disposed within a detector housing. The hollow support rod is in communication with a sample inlet. One or more wires are disposed about the support rod and are in communication with a voltage source and a signal detector. In particular examples, each of the one or more wires passes through an aperture in an insulating disk, such as a ceramic disk. During operation, the detector includes a quantity of a quench gas, such as an organic gas. In particular examples, the quench gas is methane or propane.

In further embodiments, the present disclosure provides a monitoring instrument having one or more hydrogen sorbent reactors, or getters. In particular implementations, the monitoring instrument is divided into a plurality of sections and the hydrogen sorbent reactor is in communication with each of the plurality of sections. In a particular example, the sorbent reactor may be selectively placed in communication with each of the plurality of sections, such as with a valve. In further implementations, the monitoring instrument is divided into a plurality of sections and each section includes a hydrogen sorbent reactor. In particular examples when the monitoring instrument includes multiple hydrogen sorbent reactors, the reactors include different sorbent materials.

The present disclosure also provides monitoring instruments having a sampler, such as a mechanical syringe, and a sample generator in communication with a flow control valve. In particular configurations, the flow control valve is a rotary valve that selectively places the sampler and sample generator in communication with a sample medium, such as liquid in a well. In some examples, the rotary flow control valve include a motor, an adjustable slip clutch, and a high pressure valve having a plurality of ports, such as a valve capable of withstanding pressures of at least about 1000 psi, such at least about 1500 psi. In particular examples, the high pressure valve is an HPLC valve.

Various disclosed embodiments of radiation monitoring apparatus can include additional components, such as sampling devices, flow control valves, and sensors, such as temperature, pressure, pH, dissolved oxygen, specific ion, and total gamma radiation sensors. In particular implementations, the various embodiments of radiation monitoring apparatus include detector and reactor portions separated by an isolation valve.

In particular implementations, the sampler includes a motorized syringe injector. The motorized syringe injector is configured to draw a liquid sample and transport the liquid sample to the reactor. In particular examples, the motorized syringe has an adjustable stroke. The adjustable stroke, in a particular example, is controlled with two limit switches in communication with the controller. An adjustable stroke allows for ‘tuning’ the volume of water injected into the water decomposition reactor, such as to achieve a desired hydrogen-tritium gas pressure.

The present disclosure also provides methods for radiation detection, such as for tritium detection. In particular embodiments, the method involves obtaining and decomposing an aqueous sample into hydrogen and tritium gas. The tritium is the gas is detected, such by transporting the gas to a detector, such as a proportional detector. The hydrogen and tritium gas is then removed from the instrument, such as by absorbing the hydrogen and tritium using a hydrogen getter material.

There are additional features and advantages of the various embodiments of the present disclosure. They will become evident as this specification proceeds.

In this regard, it is to be understood that this is a brief summary of the various embodiments described herein. Any given embodiment of the present disclosure need not provide all features noted above, nor must it solve all problems or address all issues in the prior art noted above.

### BRIEF DESCRIPTION OF THE DRAWINGS

Various embodiments are shown and described in connection with the following drawings in which:

FIG. 1 is a schematic diagram of a radiation monitoring apparatus according to an aspect of the present disclosure;

FIG. 2 is a flowchart of a method of operating the radiation monitoring apparatus of FIG. 1;

FIG. 3 is a schematic diagram of a particular radiation monitoring apparatus according to the embodiment of FIG. 1;

FIG. 4 illustrates a water decomposition reactor useable in the radiation monitoring apparatus of FIG. 1;

FIG. 5 illustrates a rotary valve useable in the radiation monitoring apparatus of FIG. 1;

FIG. 6 illustrates a proportional detector useable in the radiation monitoring apparatus of FIG. 1;

FIG. 7 is a flowchart of a method of operating a radiation monitoring apparatus according to FIG. 1, incorporating a rotary valve according to FIG. 6;

FIG. 8 is a flowchart of a method of operating a radiation monitoring apparatus according to FIG. 1, incorporating a rotary valve according to FIG. 6 and an isolation valve separating reactor and detector portions of the apparatus;

FIG. 9 is a schematic diagram of components of a test water decomposition reactor and proportional detector system;

FIG. 10 is a chart illustrating proportional detector performance as the percentage of propane quench gas is varied for three different tritium activities: 0 (Pure H₂ gas), 500,000 pCi/L (50 percent tritiated H₂ gas), and 1,000,000 (100 percent tritiated H₂ gas) pCi/L tritium in water;

FIG. 11 is a schematic diagram of a bench-tested radiation monitoring apparatus;

FIG. 12 is a graph illustrating hydrogen pressure and temperature rises per 1.7-mL water injection;

FIG. 13 is a graph of the effect of voltage on detector output for 1-minute counts at several tritium concentrations;

FIG. 14 is a graph of counts in 16-hours as a function of known tritium concentration in hydrogen-tritium gas. Applied voltage is 2.7 kV;

FIG. 15 is a graph of 16-hour counts for known tritium in gas and known tritium in water samples of various concentrations. Applied voltage is 2.7 kV. The diamonds represent hydrogen-tritium gas generated with a commercial hydrogen generator, and the squares represent hydrogen-tritium gas generated with a disclosed water decomposition reactor;

FIG. 16 is a graph illustrating the permeation of hydrogen through a copper-palladium membrane at several temperatures;

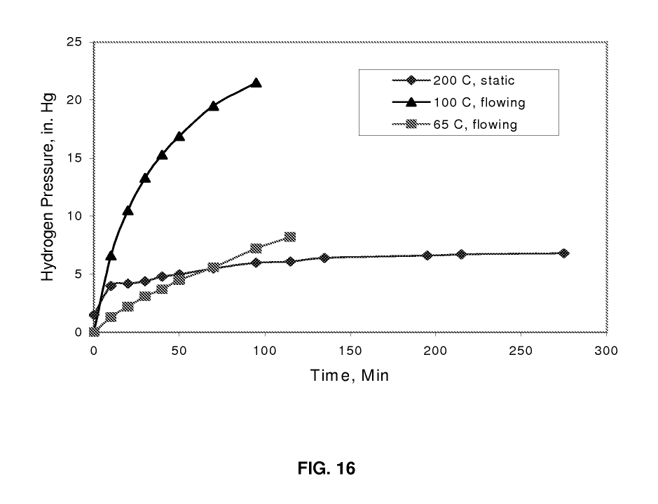

FIG. 17 is a graph illustrating hydrogen permeation through a polymeric membrane at room temperature; and

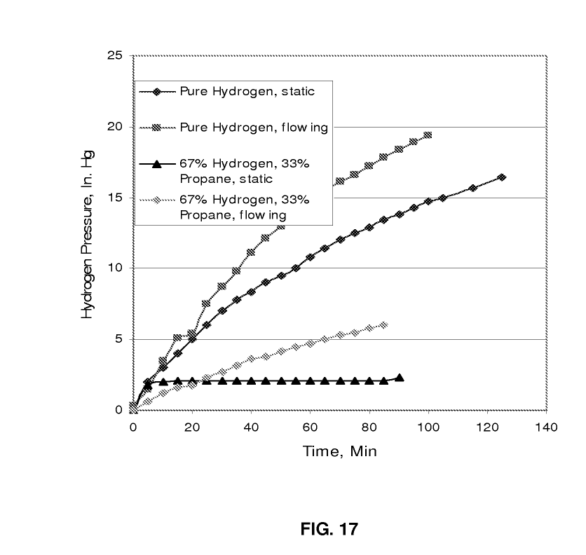

FIG. 18 is a graph of hydrogen removal versus time using a polymeric getter for consecutive loadings of hydrogen.

### DETAILED DESCRIPTION

Unless otherwise explained, all technical and scientific terms used herein have the same meaning as commonly understood by one of ordinary skill in the art to which this disclosure belongs. In case of any such conflict, or a conflict between the present disclosure and any document referred to herein, the present specification, including explanations of terms, will control. The singular terms “a,” “an,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together. All numerical ranges given herein include all values, including end values (unless specifically excluded) and intermediate ranges.

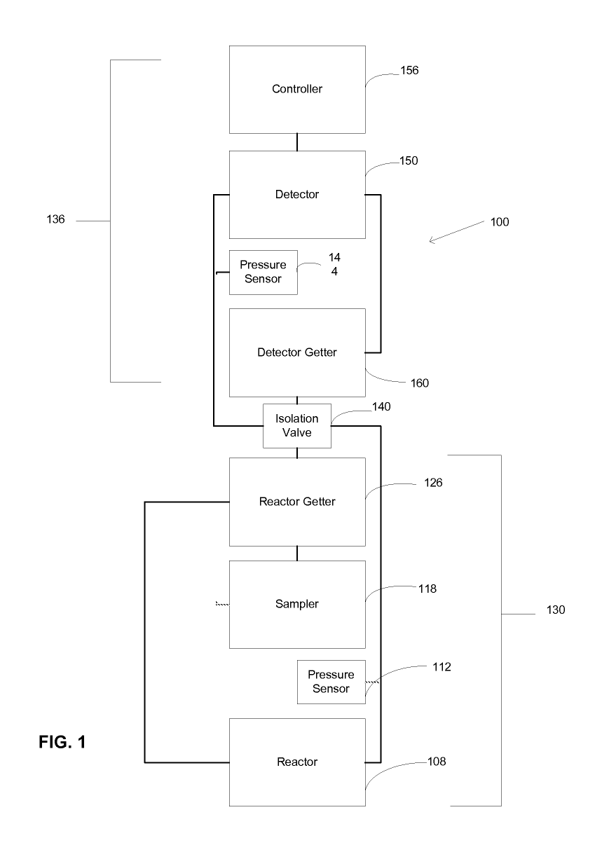

FIG. 1 presents a schematic diagram of components that may be included in various embodiments of a radiation monitoring device 100 according to the present disclosure. Starting at the bottom of FIG. 1, a reactor 108 is in communication with a pressure sensor 112, such as a strain gauge type pressure sensor. The reactor 108 is also in communication with a sampling device 118. The pressure sensor 112, reactor 108, and sampling device 118 are in communication with a reactor hydrogen getter 126. The pressure sensor 112, reactor 108, sampling device 118, and reactor hydrogen getter 126 form a reactor portion 130 of the instrument 100.

A detector portion 136 of the instrument 100 is separated from the reactor portion 130 by an isolation valve 140. The detector portion 136 of the instrument 100 includes a pressure sensor 144 in communication with a detector 150. The detector 150 is in communication with a controller 156. The detector portion 136 includes a detector hydrogen getter 160 in communication with the detector 150. The components of the device 100 may be placed in communication with one another using suitable tubing or piping, such as stainless steel piping or may be directly connected and separated by valves or similar means.

Instruments according to the present disclosure need not include all of the components shown in FIG. 1 or have the components in the same order or location. For example, the isolation valve 140 is omitted in certain implementations. In further examples, the pressure sensors 112, 144 are omitted and, optionally, replaced by flow meters or other sensors.

In operation, the sampling device 118 obtains a sample, such as a liquid sample, from a test environment, such as a well bore. The sample is injected from the sampling device 118 into the reactor 108. The reactor 108 converts the sample into a form suitable for use in the detector 150. In a particular implementation, the reactor 108 decomposes an aqueous sample into one or more gaseous components, such as hydrogen, and other reaction products. For example a sample of tritiated water may be converted to hydrogen gas, tritium gas, and oxides.

Gas formed in the reactor 108 is transferred through the pressure sensor 112 to the detector 150 through the isolation valve 140. The pressure sensor 112 can be used to determine the amount of gas generated by the reactor 108. Knowing the volume of gas generated allows the amount of sample to be accurately determined, such as from the ideal gas law. The volume of gas can also be measured before the sample enters the detector 150, such as by the pressure sensor 144.

The reactor hydrogen getter 126 is used to remove, or sequester, hydrogen generated by the reactor 108 from the components of the reactor portion 130. Hydrogen removal helps to ensure that a particular test measures only the gas produced by the sample, not residual hydrogen and tritium that may otherwise remain in the instrument 100 from a previous test.

The isolation valve 140 separates the reactor portion 130 from the detector portion 136. Separating the reactor portion 130 from the detector portion 136, along with the use of a separate detector hydrogen getter 160, may aid in clearing hydrogen from the device. In addition, separating various getters in the instrument 100 may allow different getter materials to be used in different portions of the instrument 100. In one particular implementation, isolating the reactor getter 126 from the detector portion 136 during detection allows a less expensive or efficient gettering material to be used in the reactor getter 126. Isolating the reactor getter 126 from the detector portion 136 may also allow getter material to be used that would otherwise be incompatible with the detector portion 136, such as with a quench gas.

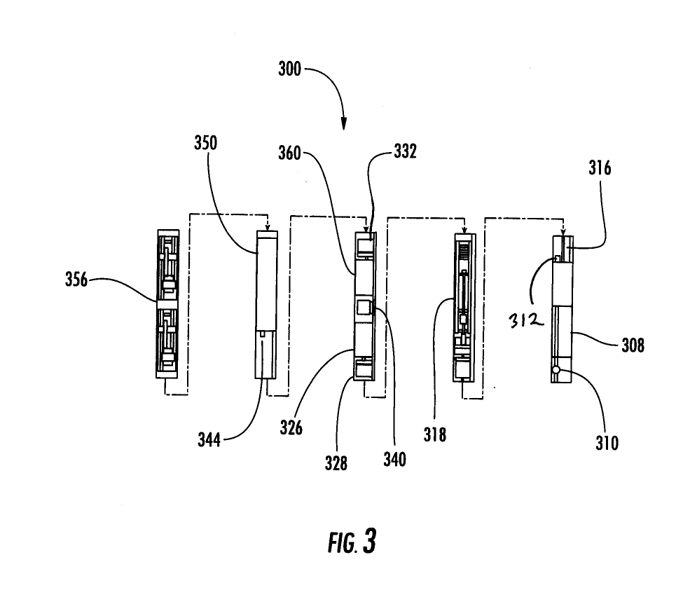

The detector 150 detects one or more radioactive components of interest, such as tritium gas. In particular examples, the detector 150 includes a quench gas, such as when the detector 150 is a proportional detector. The quench gas is typically an organic compound, such as propane or methane, a mixture of organic compounds, or an inorganic gas. The quench gas, in some examples, is initially dosed to the instrument 100 through a fill valve (FIG. 3, 310) prior to the instrument 100 being deployed for testing. To help prevent interaction between the metal alloy and the quench gas, the isolation valve 140 can be included to help preclude the transport of quench gas from the detector portion 136 to the reactor portion 130.

The detector 150 is in communication with the controller 156. The controller 156 may be used to operate the instrument 100, perform data analysis, or communicate with a user, such as a remote user, or remote systems.

The present disclosure is not limited to the configuration of FIG. 1. For example, certain embodiments do not include one or more of the components shown in FIG. 1, such as the isolation valve 140, separate reactor 126 and detector 150 getters, or pressure sensors 112, 144. The device 100 can include additional components, such as additional detectors for detecting other sample components, such as sensors to quantify organic or inorganic compounds present in a sample. Additionally, the controller 156 may be configured to communicate with other commercially available sensors such as, but not limited to, sensors for pH, dissolved oxygen, specific ion, and total gamma radiation. In further implementations, the functions of multiple components may be combined in a single unit, such as a combined detector 150 and controller 156. The components of the apparatus 100 may be connected and arranged in a different manner than illustrated in FIG. 1. For example, the controller 156 may be located remotely from the remainder of the apparatus 100.

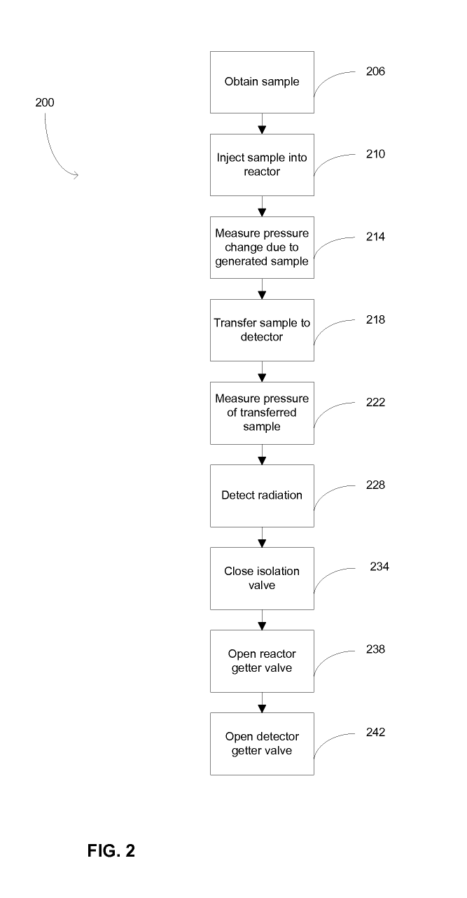

FIG. 2 presents a flowchart of a method 200 of operating the instrument 100 of FIG. 1. At step 206, a sample is acquired with the sampler 118. The sample is injected into the reactor 108 at step 210. In the reactor 108, the sample may be converted to a form suitable for use in the detector 150, such as a gas. The pressure of the generated gas is measured in step 214 by the pressure sensor 112. At step 218, the generated gas is transferred to the detector 150 through the isolation valve 140. At step 222, the pressure of the gas transferred to the detector 150 is measured by the pressure sensor 144. The mass of the generated gas is then calculated from the pressure measurement made by pressure sensor 144, such as through the use of the ideal gas law and the known volume of the detector 150 and associated connections.

The isolation valve 140 is closed at step 234 when the pressure difference between the reactor pressure sensor 112 and the detector pressure sensor 144 has achieved a certain positive value, thereby ensuring gas flow from the reactor 108 to the detector 150. Pressure in the detector 150 is monitored and allowed to stabilize before applying voltage to the detector. The radioactivity of the sample is then quantified by the detector 150 and the controller 156 at step 228.

At step 234, typically while radiation is being detected at step 228, and while the isolation valve 140 is closed, the reactor getter valve is opened at step 238, allowing the remaining hydrogen-tritium gas sample to be removed from the reactor portion 130 of the instrument 100. Once detection has been completed, a valve to the detector getter 160 is opened, allowing sample to be removed from the detector portion 136 of the apparatus 100. Gettering proceeds until a certain pressure has been achieved in both the reactor portion 144 and the detector portion 130 as determined by monitoring the pressure sensors 112 and 144. In certain instances the residual pressure in the reactor portion 144 as measured by the pressure sensor 112 will be a vacuum, while in certain other instances the residual pressure in the detector portion 130 as determined by the pressure sensor 144 will be the partial pressure of the quench gas.

FIG. 3 presents a schematic diagram of a particular implementation of the device 100 of FIG. 1. The device 300 contains the same components as the device 100, which are correspondingly labeled. The reactor 308 is connected to a valve 310 that may be used to evacuate the reactor 308 with a vacuum pump system, charge the reactor 308 with reactant or purge the reactor 308 with gas, as explained in more detail below. A liquid conduction line 316 connects the sampling device 318 with the reactor 308. A gaseous conduction line (not shown) connects the reactor 308 with the reactor pressure sensor 312, the reactor getter 326, the detector 350, and the detector getter 360 with valves (not shown) controlling gas flow to each of these components.

The sampling device 318 is configured to operate at the ambient temperatures and pressures in the environment in which the device 300 will be used. When used to measure tritium in a well bore, such pressures can range up to 1,800 psig or higher. In particular embodiments, the sampling device 318 is a mechanical syringe, such as a mechanical syringe with an adjustable stroke. In a specific example, the stroke of the mechanical syringe can be configured using two limit switches in communication with the controller 356. An adjustable stroke allows the volume of water obtained by the sampling device 318, and subsequently injected into the reactor 308, to be tuned to provide a desired sample volume. Suitable motorized syringes include those used in commercially available well logging injector tools.

Although the device 300 uses a syringe based sampling device 318, any suitable sampling device can be used. In certain examples, the sampling device 318 is a free piston hydraulic machine, which in more specific examples is powered by the pressure difference between the borehole hydraulic head and the vacuum pressure within the reactor portion 130. This embodiment is particularly useful when the instrument 100 is deployed to depths in excess of a certain value because it does not require any additional power to operate, and can simplify the electromechanical aspects of the sampler 118. At shallower deployment depths, the pressure gradient between the borehole and the reactor portion 130 is typically not great enough to inject a water sample into the reactor 108 to ensure complete reaction of the sample with the metal alloy, and the electromechanical syringe injector is therefore typically used.

The reactor portion of the device 300 includes a reactor getter unit 326. The reactor getter unit 326 includes a valve 328 that can be selectively opened. The reactor getter can be any suitable shape and is typically sized to hold a desired amount of sample and getter material. In particular embodiments, the reactor getter unit is cylindrical and constructed from stainless steel. The getter material may be placed loose in the reactor getter 326 or may be placed in a permeable container. For example, the getter material may be placed in a sock of material. In further implementations, a gas permeable barrier is placed between the getter material and the remainder of the getter unit 326 to secure the getter material in the getter unit 326.

Any suitable hydrogen absorbing material can be used in the reactor getter unit 326. Two suitable types of getter material are metallic getter materials (various metal oxide based products, such as those described in U.S. Pat. No. 4,668,424) and polymeric getters, such as those having platinum bearing groups. Suitable polymeric getters are available from Sandia National Laboratories. One such class of materials is described in U.S. Pat. No. 7,001,535.

The getter material is chosen to remain active in the presence of gases to which the getter material will be exposed. For example, quench gasses such as propane or methane may poison certain metallic getters. In certain implementations, such as when an instrument is desired which can perform multiple tests before requiring maintenance, it may be desirable for the getter material to be regenerable.

When a measurement takes place, the valve 328 is closed, and the gas sample generated by the reactor 308 is transferred to the detector portion of the device 300 through the isolation valve 340. Once the generated sample gas has been transferred to the detector portion, the valve 328 is opened, allowing hydrogen gas in the reactor portion to be sequestered by the getter material.

The isolation valve 340 may be any suitable valve, and is typically in communication with, and controlled by, the controller 356. In particular examples, the isolation valve 340 is an electrically operated solenoid valve. Suitable valves are commercially available from Snap-Tite, Inc., of Erie, Pa., and may be magnetically-latching or non-latching valves. Magnetically latching valves are particularly suitable if the isolation valve 340 will be left open for extended periods of time.

Turning now to the detector portion, the detector getter 360 may be constructed in a manner similar to the reactor getter 326. A getter material is typically selected that will not be poisoned by the quench gas. For example, when the quench gas is organic, the getter material can be a polymeric getter material. Because it separates the detector portion, which contains a quench gas, from the reactor portion, which does not contain a quench gas, the isolation valve 340 allows less costly, potentially less efficient getter materials to be used in the reactor portion. The isolation valve 340 also allows the getter material in the reactor portion to remove hydrogen while detection is taking place in the detector portion, potentially a significant amount of time. Providing a longer time for removing hydrogen may allow a wider variety of getter materials to be used. Like the reactor getter unit 326, the detector getter unit 360 includes a valve 332 that can be selectively opened and closed to allow the getter unit 360 to be placed in fluid communication with the remainder of the detector portion.

A pressure sensor 344 is positioned intermediate the detector 350 and the isolation valve 340 in the sample flow path. The pressure sensor 344 allows the quantity of sample gas reaching the detector 350 to be measured by the controller 356.

The detector 350 may be any suitable detector, such as a gas scintillator detector or a proportional detector. The detector 350 is typically constructed to operate at the ambient conditions, including potentially high pressures and temperatures that may be encountered when the instrument 300 is in use.

Controller

The controller 356 includes a microprocessor that communicates with a remote system (not shown). In particular examples, the controller 356 is a microprocessor operable in a down-hold environment and the remote system is a surface module incorporating features such as an additional microprocessor, communications equipment, batteries, or solar panels. Suitable controllers 356, and remote systems, may be obtained from Campbell Scientific, Inc., of Logan, Utah. The CSI 1000 controller is one such suitable device.

The controller 356 and surface module may be placed in communication using a cable, such as an armored multi-conductor steel cable of the sort used by geophysical borehole logging equipment. The controller 356 communicates with the surface module via the cable using a complex command script transmitted via standard RS232 protocol. However, other protocols may be used. The controller 356 is configured to operate the valves of the instrument 300, such as the isolation valve 340, the detector getter purge valve 332, and the reactor getter valve 328. The controller 356 also powers the detector 350 and collects the signal from the detector 350.

In particular examples, the controller 356 includes separately addressable sections or circuit boards; including one or more modem/microprocessor boards, solenoid boards, and spectrometer boards. Information from the surface module is received by the modem/microprocessor board, interpreted by the controller 356, which in turn passes on commands to the appropriate board. The surface module may also issue commands to query information stored in the controller 356, such as pressure and temperature readings from the reactor 308 or detector 350, cycling information from the motorized syringe and rotary inlet valve, and counts from the spectrometer board.

In this example, each solenoid board is capable of controlling 4 latching DC solenoids and has measurement input channels for a pressure transducer and a thermister temperature sensor. A pulse of positive polarity supplied to a solenoid magnetically latches the value to an open position; conversely, a pulse of negative polarity to the solenoid returns the valve to a normally closed position.

Power is supplied the device 300 from land surface via a surface module, such as from solar panels, batteries, or an AC line sources. The surface module supplies DC voltage to the wireline that serves as both the mechanical support and means of communication with the device 300. A voltage regulator board co-located with the controller 356 distributes incoming power from the surface module to the various electrical components of device 300. In the embodiment described in FIG. 3, these components include +/−3 VDC to solenoids, +/−50 VDC to the motorized components, and +14 VDC to the controller 356. In addition, the controller 356 has a 12 VDC sealed lead acid battery that acts as a buffer against voltage variations from the surface module.

The spectrometer board supplies high voltage to the detector 350 and amplifies and counts low voltage pulses produced by tritium disintegrations in the detector 350. The high voltage power supply is software controllable from 0 to 5000 volt DC, in (256)² increments (5000 volts divided by 65536 increments=76 millivolts resolution). Pulses from the detector 350 are counted in 256 spectral energy bins. Each energy bin is capable of accumulating up to 65536 counts (256²) before the bin is full, at which time the bin will overflow and no more pulses will be counted. The energy bin threshold and span are software controllable and therefore can be adjusted to a small energy window specific to tritium, or can be adjusted to a broader window, such as for measuring tritium and radon.

Sample Reactor

As explained above, the disclosed devices, such as the devices 100 or 300, may be designed to detect tritium, which emits a low energy β-particle (18.6 KeV). This energy is so low that the emitted β-particle is absorbed even by air. Rather than a detector with a window, which may be impenetrable to the β-particles, at least certain disclosed devices are designed to place tritium in intimate contact with the detector, such as in the above described scintillation and proportional detection systems.

One means of placing tritium in intimate contact with a detector is to convert the tritium in water to ³H₂ gas. Detection of radiation in gas can have advantages over aqueous detection systems. First, hydrogen-containing tritium will be devoid of ¹⁴C, ⁴⁰K, ²³⁸U or any other radioactive isotope (except ²²⁶Rn, which is gaseous). Second, the hydrogen-tritium can be passed through activated carbon to remove up to 99.9 percent of the radon. The remaining radon activity can be separately counted because of the large energy difference between it (6,000 KeV) and tritium (18.6 KeV). Alternatively, the tritium can be counted after waiting a relatively short period of time after gas formation to allow the very short half-life of radon to lower the activity of radon to below detectable levels. Alternatively, the activated carbon filter can be omitted and radon can be excluded from measurements by waiting until the radon naturally decays. The use of purified hydrogen/tritium gas can thus greatly minimize the background radiation admitted into the detector 350 and allow relatively low levels of tritium to be detected.

There are two common methods of decomposing water into hydrogen (or tritium) gas. One method uses electrolysis to reduce the H⁺ ion of water into elemental hydrogen, H₂, and oxidizes the O²⁻ into elemental oxygen, O₂. The second method uses chemical reactions, such as reaction with very active metals such as sodium, potassium, lithium, calcium, or combinations thereof, such as alloys, to decompose water into hydrogen and metal hydroxide.

Elemental sodium and potassium can be combined to form a eutectic alloy that is molten at room temperature. This alloy is commercially available from BASF Corporation of Florham Park, N.J., in the ratio of 78 percent potassium and 22 percent sodium, and is referred to as NaK. Since it is a liquid, NaK can be relatively easily transferred into the reactor 308, such as by pumping the NaK into the water decomposition reactor 308.

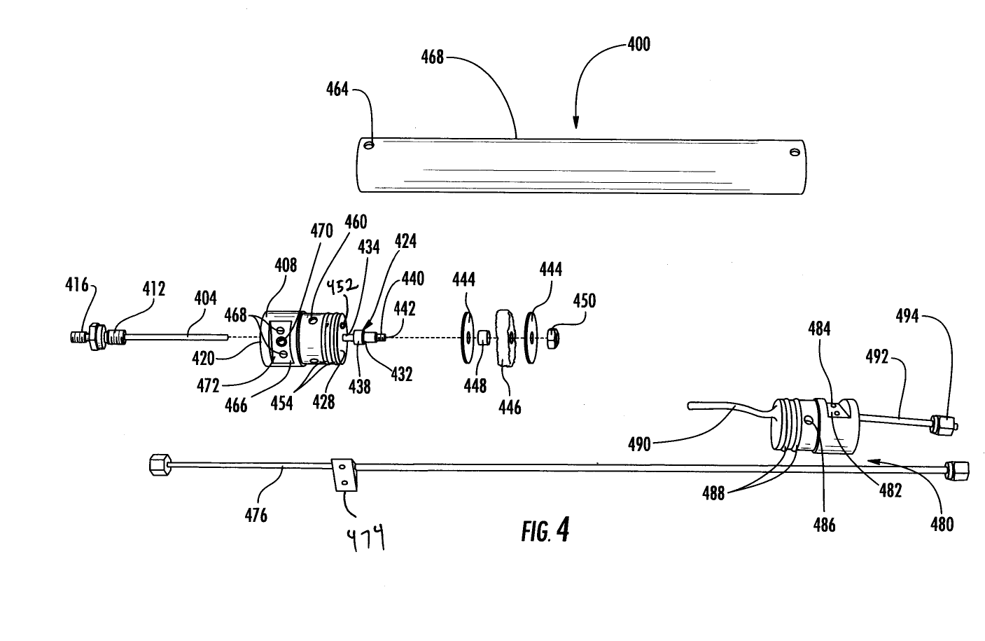

The reactor 400 shown in FIG. 4 provides a suitable reactor for reacting a liquid sample with NaK in a remote setting. A removable needle 404 is insertable into the top end 408 of the reactor 400. The removable needle 404 may be secured by a threaded barrel 412 received by mating threads of a bore (not shown) formed in the top end 408 of the reactor 400. A smaller diameter threaded barrel 416 extends opposite the threaded barrel 412 and may be used to connect the reactor 400 to other components, such as a sample source. For example, the threaded barrel 412 may connect the reactor 400 to the sampling device 118, 318.

A hollow shaft 424 of a baffle structure extends perpendicularly from an inner surface 428 of the top end 408. The shaft 424 includes a generally frustoconical portion 432 which abuts a narrow portion 434 of the shaft 424 proximate the inner surface 428. The frustoconical portion 432 has a thickened end 438 and a threaded portion 440 intermediate the thickened end 438 and an outer end 442 of the frustoconical portion 432.

Two washers 444 are placed over the frustoconical portion 432 of the shaft 424. Bronze or stainless wool 446, or similar non-reactive material, is placed between the washers 444. The wool 446, when mounted on the shaft 424 with a spacer 448 and nut 450, serves to help prevent material other than the gas sample from entering an aperture 452 formed on the inner surface 428. The aperture 452 is located approximately midway on the radius of the inner surface 428.

Two circumferal channels are formed in the side of the first end 408 of the reactor 400. Each channel may be fitted with an O-ring 454. The O-rings 454 may be made from any suitable material, which are typically resilient and non-reactive towards water, NaK, heat, and the mineral byproducts of the reaction of water and NaK. In particular examples, the O-rings 454 are formed from rubber or another polymer. In a more particular example, the O-rings 454 are buna-n O-rings. The O-rings 454 are typically selected to be of a size to provide a tight seal between the first end 408 of the reactor 400 and the remainder of the reactor 400.

A plurality of threaded bores 460 are formed in the side of the first end 408 of the reactor 400. The threaded bores 460 are configured to receive matingly fitted screws (not shown) inserted through apertures 464 formed in the reactor body 468. Three rectangular depressions 466 are formed in the outer end of the first end 408 of the reactor 400. Two threaded bores 468 are formed in each of the rectangular depressions 466. The threaded bores 466 may receive matingly threaded screws (not shown). The screws may be used to attach the reactor 400 to other components of a radiation monitoring device, such as the radiation monitoring device 100 or 300, such as a gas manifold (described further below).

In a particular example, one rectangular depression 466 has an aperture 470 in communication with the aperture 452 of the inner surface 428. The aperture 470 is surrounded by a channel that receives an o-ring 472. The o-ring 472 may be selected as described for o-rings 454. In other examples, another rectangular depression 464 has an aperture (not shown) in communication with an aperture if the end 442 of the shaft 424.

The top end 408 of the reactor is attachable to one or more gas manifold assemblies 474. Each gas manifold assembly 474 includes a passage for transferring gas between the reactor 400, an assembly 474, and other portions of a monitoring instrument. Gas transfer tubing 476, which is made of stainless steel in some examples, is attached to the manifold 474. Monitoring instruments according to the present disclosure can use other types of has assemblies, such as a manifold block having a solenoid valve and a T-joint. In other implementations, an end fitting of the reactor serves as the base for the solenoid valve, fasteners used to secure the manifold to the fitting may have passages or bores to allow gas to be transferred to or from the reactor.

A number of rectangular depressions 482 are formed in a lower end 480 of the reactor 400. Two threaded bores 484 are formed in each of the rectangular depressions 482. Matingly threaded screws (not shown) may be inserted into the threaded bores 484 to secure the lower end 480 to other components of the reactor 400. A plurality of threaded bores 486 are formed in the side of the lower end 480. Matingly threaded screws (not shown) may be inserted into the threaded bores 486 to secure the lower end 480 to the reactor body 468. A plurality of channels are formed in the side of the lower end 480. O-rings 488 are placed in the channels and may be selected as described for O-rings 454.

A pipe 490 having a slight s-curve towards its middle extends outwardly from an inner surface of the lower end 480. The pipe 490 is in fluid communication with a pipe 492 extending from the outer end of the lower end 480. In particular implementations the pipe 492 is the same as the pipe 490. The pipe 492 includes a fitting 494 for attachment to other components of a device 100, 300.

The reactor 400 operates as follows. A quantity of NaK is pumped into the pipe 492. The amount of NaK introduced into the reactor 400 is greater than the volume of the reactor below the top of the pipe 490. An inert gas, such as argon, is then introduced into the reactor 400, such as through the manifold 474, to push NaK above the level of the pipe 490 through the pipe 490. Bubbles of the gas appearing in the NaK removed from the reactor 400 indicate that the NaK level in the reactor 400 is even with the top of the pipe 490. Although other methods of introducing NaK into the reactor may be used, this disclosed method allows a known quantity of NaK to be accurately and conveniently introduced into the reactor 400.

When a radiation measurement is to be obtained, a quantity of sample is injected into the reactor 400 through the needle 404. The sample is injected with sufficient force to break through the surface of the NaK layer, ensuring that the sample contacts active NaK, rather than other materials, such as mineral products, that may be present on the surface of the NaK. The needle 404 may be chosen to be of a gage suitable for achieving the desired sample velocity once in the reactor 400. In a particular example, the needle is a 22 gage needle.

The reaction of the sample with NaK produces metal oxides and hydrogen and tritium gas. Gas generated from the reaction passes through the aperture 452 in the inner surface 428 of the upper end 408 and through the aperture 470 formed in the rectangular depression 466. The shaft 424, including the washers 444 and bronze wool 446, at least partially cover the aperture 452. The wool 446 helps prevent NaK, metal oxides, and other materials from being transported to other components of the instrument 100, 300, aiding in preventing corrosion and contamination, and potentially reducing maintenance needed on the instrument 100, 300. Locating the needle 404 inside the hollow shaft 424 similarly helps prevent material from depositing on and possible damaging or obstructing the needle 404.

The components of the reactor 400 are constructed from suitably strong, inert materials, such as stainless steel. The reactor 400 is constructed to withstand operating temperatures, pressure, and moistures encountered by the apparatus 100, 300. The reactor 400 is also constructed to withstand the pressures generated by the reaction of the sample with the NaK, as well be relatively inert to NaK, moisture, and NaK reaction products. The reactor 400 is dimensioned to provide a suitable sized space to promote the reaction of the sample with the NaK, generate a desired pressure upon reaction of the NaK with the sample, and hold a quantity of NaK sufficient to perform a desired number of measurements before maintenance on the reactor 400 is needed, such as emptying the reactor 400 and recharging it with a quantity of NaK.

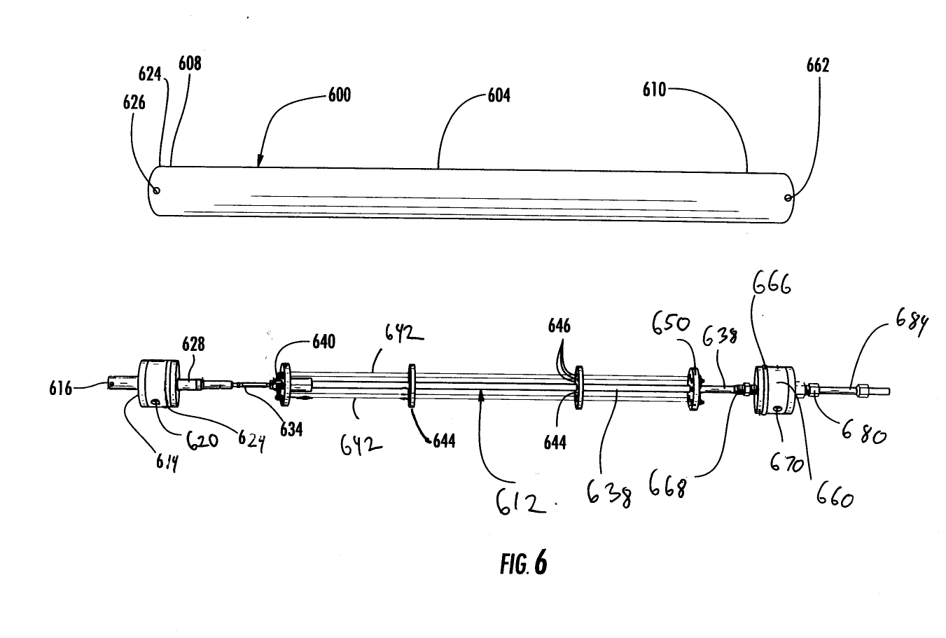

Two valves (not shown) located at the bottom of the reactor 400 are used to prepare the instrument 300 for operation. These valves are used to transport gaseous components, and NaK. A gas fill valve is used to evacuate the device 300 to remove atmospheric gases, including water vapor, such as using a high-vacuum pumping system (not shown). The gas fill valve is also used to dose the quench gas to the detector (FIG. 6). The isolation valve (340, FIG. 3) is then closed, and the reactor 400 is then evacuated of quench gas with the vacuum pumping system. A NaK fill valve, connected to fitting 494, is then used to fill the reactor 400 with NaK as previously described. The gas fill valve is then used to admit Argon, or some other suitable inert gas, to the reactor to push NaK back out of the reactor to the top of pipe 490. Both of these valves are then sealed closed and the pressure tight compartment re-established in preparation to deploy the instrument, such as into a well, borehole, or other space to be sampled for radiological constituents.

Rotary Valve

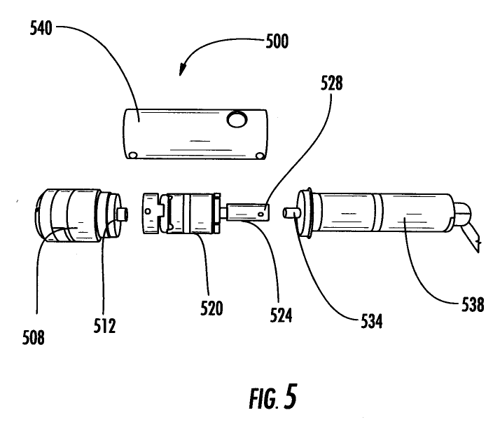

In particular implementations, the sampling device 118, reactor 108, and detector 150 are selectively placed in communication through a rotary valve. Suitable rotary valves may be fabricated using a high performance liquid chromatography switching valve and a high performance motor and gearhead coupled through an adjustable slip clutch. For example, FIG. 5 illustrates a rotary valve 500 constructed from a Rheodyne Corporation (Rohnert Park, Calif.) model 7000L HPLC valve 508 having an axially extending shaft 512. The axially extending shaft 512 is received by a mating aperture formed in an adjustable slip clutch 520, model SC-15 from Reell Corporation (St. Paul, Minn.). The adjustable slip clutch 520 has an axially extending transfer shaft 524. An aperture 528 is formed in the end of the transfer shaft 524 and is received by a mating drive shaft 534 axially extending from a motor 538, which in particular examples is a DC motor and planetary gear reduction case from Maxon Motors Corporation (Fall River, Mass.), models RE-25 and GP-26-B. The adjustable slip clutch 520 and the shafts 512, 524, and 534, are enclosed within a torque housing 540.

The rotary valve 500 switches flow from a sample source, such as a borehole, to the sampling device 118, between the sampling device 118 and the reactor 108, and between the reactor 108 and the isolation valve 140. The rotary valve 500 may be used to interconnect additional components, such as chemical detectors, included in the device 100.

Detector

Gas scintillator detectors typically operate in a similar manner to liquid scintillation detectors in that a gaseous scintillant mixture reacts with radiation to produce light which is then quantified with a sensitive light detector. Compared to proportional detectors, scintillation based tritium detector systems are potentially not as sensitive as gas-proportional detector systems. The chemical reactor retains most radioactive constituents contained in the water sample, producing a sample gas with comparatively little interfering radiation. Because the proportional and scintillation systems are typically of similar complexity and require similar mechanical and electronic equipment, it may be advantageous to use gas-proportional detector systems in many applications, particularly because of their greater sensitivity to low radiation particles.

Proportional detectors operate by directly quantifying the interaction of a charged particle with the detector. When a tritium atom decays by emitting a β-particle, the particle travels until it strikes a gas molecule where it is adsorbed and forms an electron-ion pair. If the voltage is high enough, the electrons from this primary ionization are given enough energy to ionize additional gas molecules in a process called secondary ionization. This results in charge multiplication that is proportional to the number of β-particles emitted. Thus, the proportional detector acts as a detector and signal amplifier in one unit. In some circumstances the interaction of the emitted electron with a gas molecule does not occur with enough energy to produce a secondary electron, but produces what is called ‘simple excitation’ of gas molecules. These excited gas molecules decay to their ground state through the emission of a photon. These photons can lead to additional photon-gas reactions, which lead to a loss of detector proportionality and chaotic signal behavior. To suppress the effects of simple excitation, a polyatomic fill gas is used to adsorb the simple excitation decay photon flux. This fill gas is referred to as a ‘quench gas.’ Proportional detectors typically operate at an applied potential of 1,000-3,000 volts.

The signal from a proportional detector can be “conditioned” to eliminate the contributions from other radiation, such as from radon. This is because radon emits a 5,590 KeV α particle versus the 18.6 KeV β particle of tritium. The detector amplifier electronics can be designed to discriminate between different decay energy signatures, which in turn allows the proportional detector to quantify both tritium and radon at the same time. The proportional detector 350 can be operated to detect the β decay from tritium even in the presence of high energy alpha and gamma radiation from other radioactive isotopes, such as radioactive isotopes naturally present in rock surrounding a well casing and in well water.

Suitable proportional detectors 350 may be constructed in a manner similar to the conceptual design described in Knoll, Radiation Detection and Measurement, 3d Ed. (2000). In a specific implementation, the detector 350 includes two charged surfaces, energized by the controller 356 and a high voltage power supply supplying various voltages up to 5 kV. In certain examples the body of the detector 350, which serves as a gas-tight vessel, is the cathode. In some examples, the anode is constructed of fine wire which can be present as a single, centrally placed electrode or as multiple wires arrayed radially about the central axis of the detector 350 body. In a specific example, the proportional detector 350 contains several fine wire electrodes (such as wires having a diameter of about 2.54×10⁻³ cm) electrically insulated from the detector body. The use of multiple fine wire electrodes can improve detector sensitivity.

FIG. 6 illustrates an example of a proportional detector 600 useable in the devices of the present disclosure, including the instrument 100 (FIG. 1). The detector 600 includes a hollow cylindrical sheath 604 having an upper end 608 and a lower end 610. A detector assembly 612 is insertable into the sheath 604.

The detector assembly 612 includes a generally cylindrical upper pass-through fitting 614. The fitting 614 has an axially extending, hollow cylindrical protrusion 616. An electrical connector (not shown) is disposed in the protrusion. The protrusion 616 to allow a sample to enter, and be removed from, the detector 600. The electrical connector allows detector signals to be transmitted to other system components for processing and can provide an electrical feed through to energize the detector. In particular examples, the electrical connector is a gas-tight, high-voltage feed through from CeramTec North American Corporation (Laurens, S.C.), Part No. 17213-01-W. Two locking pegs extend radially outwardly form the protrusion 616 and allow the detector 600 to be connected to other components of an instrument.

The fitting 614 includes a mounting aperture 620 into which a mounting screw, bold, or other fastener, can be inserted, such as to secure the detector assembly 612 to the sheath 604. An o-ring 624 is included in a groove in the fitting 614, which can help provide a tight seal between the fitting 614 and the sheath 604.

The electrical connector 618 extends through the fitting 614 and an interior end of the connector 618 is in connected to a push-pin electrical connector 628, which is in turn received by a mating copper connector 634. The copper connector 634 is disposed within a support nut 636 which is also connected to a gas transmission and support rod 638 and a ceramic insulator 640 having apertures through which six wires 642, such as 0.001 diameter stainless steel wires extend. The wires 642 are soldered in series and then to the copper connector 634. The wires 642 extend along a portion of the length of the rod 638. Two supporting ceramic insulators 644 are disposed along the length of the rod 638. The insulators have apertures 646 through which the wires 642 pass. The insulators 644 help maintain the position of the wires 642 and to prevent shorting of the wires 642, such as by touching the sheath 604 during use.

A bottom ceramic plate 650, through which the rod 638 passes, is disposed towards the bottom of the detector assembly 612. The wires 642 pass through the ceramic plate and are secured and soldered together on the exterior surface of the plate 650.

The bottom of the detector assembly 612 includes a fitting 660, which is generally constructed in a manner similar to the fitting 614, including having an o-ring 666 and a fastener aperture 670. The interior surface of the fitting 660 includes an axially extending connector 668 that receives the rod 638. A connector 680 extends from the exterior surface of the fitting 660 and may be used to attach the detector 600 to a gas input line 684.

During operation, the detector assembly 612 is placed within the sheath 604 and the assembled detector 600 is secured by inserting fasteners through apertures 690 in the sheath 604 and into respective apertures 620, 670 of the fitting 614, 660.

During operation, the detector 600 is charged with a quench gas through a gas input line. The gas passes through the rod 638 and out of the nut 636. A sample gas is similarly introduced into the detector 600. Radiation from the sample gas contacts the wires 642 and the signals are transmitted to a controller through the electrical connector 618. After a particular measurement, the detector 600 can be opened to a getter unit for removal of the sample.

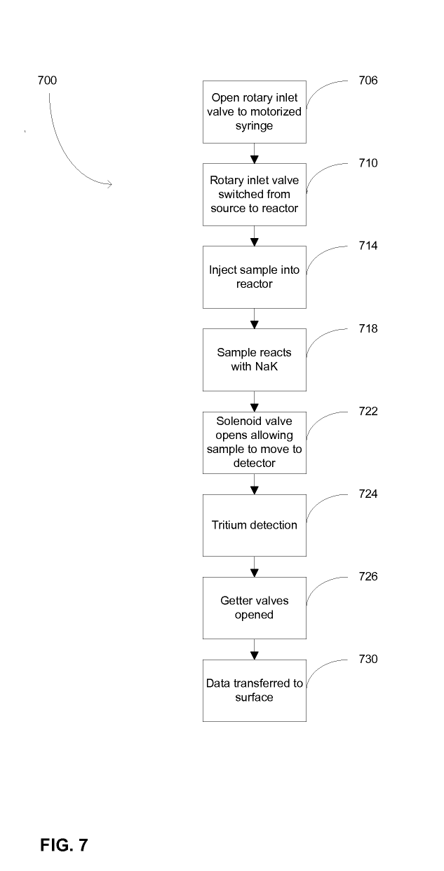

As discussed above, the operation of the device 300 is controlled by the controller 356 and proceeds as illustrated in FIG. 7. At step 706, the motorized high-pressure rotary inlet valve 500 of the instrument 300 is opened and the motorized syringe 318 pulses water into and out of the syringe barrel. This flushing removes water in the lines from the previous sample and assures that a representative sample goes to the reactor 308. At step 710, the rotary valve 500 is closed to the borehole and opened to the water decomposition reactor 308 after a final suction stroke of the motorized syringe 318. The motorized syringe 318, at step 714, rapidly injects an aliquot of water into the reactor 308.

At step 718, the aliquot of water reacts with a charge of 22 percent sodium-78 percent potassium alloy. The reaction produces hydrogen-tritium gas sufficient to generate a pressure of 75 psig (0.83 MPa) pressure in the reactor and solid sodium and potassium hydroxides. The hydroxide products have a larger specific gravity than NaK and sink to the bottom of the NaK pool, exposing fresh alloy for succeeding reactions and analyses until the NaK is depleted.

Following reaction of the sample and the NaK, at step 722 the isolation valve 340 opens and allows the hydrogen-tritium gas to move into the proportional detector 350. The controller 356 operates the detector 350 and collects count statistics from the sample at step 724. Once the count has proceeded such that a predetermined set of statistics are met, at step 726 two additional solenoid valves 328, 332 open, allowing the hydrogen-tritium gas to enter the getters 326, 360. The getters 326, 360 contain a hydrogen sorbent ‘getter’ material that sorbs hydrogen onto a solid-phase substrate, removing hydrogen and tritium gas from the instrument. Following step 726, the instrument 300 is ready for the next sampling event. At step 730, data is transferred to a surface-located computer from the controller 256. The surface computer may, in turn, send the data to a remote computer server, such as by land-line telephone, satellite phone, or radio frequency communications.

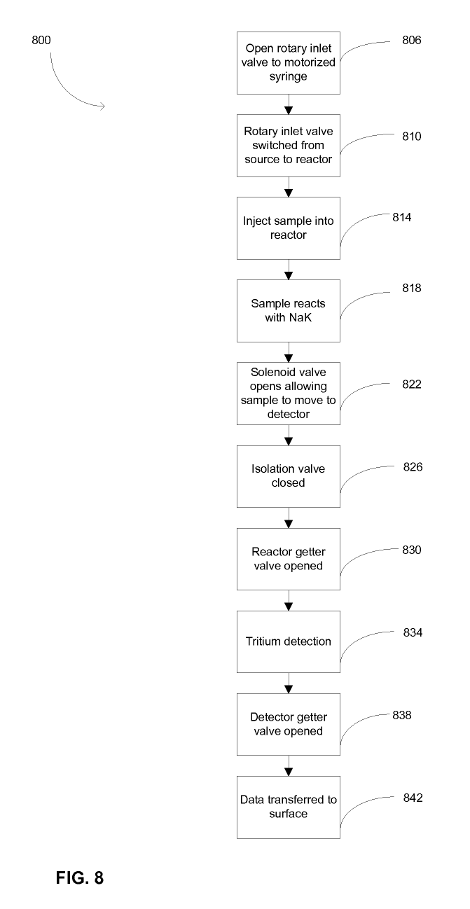

FIG. 8 illustrates an alternative method 800 of operating the instruments 100, 300 having separate reactor and detector getter units. At step 806, the rotary valve 500 connects the sampling device 318 to a sample source. The rotary valve connects the sampling device to the reactor 308 at step 810. The sample is injected into the reactor at step 814. At step 818, the sample reacts with the NaK, generating hydrogen and tritium gas.

The isolation valve 340 is opened at step 822, allowing the sample gas to enter the detector 350. At step 826, the isolation valve 340 is closed. Once the isolation valve 340 is closed, a reactor getter valve is opened at step 830, allowing hydrogen to be removed from the reactor portion of the instrument 300.

At step 834, tritium, or other radioactive material, is detected by the detector 350. Once detection 350 has completed, a detector getter valve is opened at step 838, allowing hydrogen to be removed from the detector portion of the instrument 300. At step 842, data is sent from the controller 356 to a surface computer.

The disclosed monitoring instruments can be configured to fit within standard monitoring wells. Although particular disclosed exemplary computer packages are housed in a 10.16 cm diameter pressure housing, the computer boards can be designed to fit in a 4.45 cm diameter pressure housing. The 10.16 cm diameter instrument disclosed herein can be a standard design for most monitoring well applications. The instrument can be modified to meet the 4.45 cm diameter criterion for use in 5.08 cm diameter wells, such as by decreasing the size of the gas control valves.

The disclosed design may be modular and is adaptable to specific end-user requirements. The present disclosure provides, in certain embodiments, a monitoring device that provides:
Complete in situ operation: no material exchange between the borehole and the surface.
Solar powered with remote communication and complete computer control.
An outside instrument diameter of 1.75 in (4.45 cm), deployable down-hole in 2 inch (5.08 cm) diameter wells;
All stainless steel construction, deployable to pressures of 1,800 psig;
Lower detection limit of tritium in water of 1,000 picoCuries per liter (pCi/L);
Accuracy of ±3 percent at any activity up to 680,000 pCi/L (upper limit of laboratory testing).
Ability to interrogate a vertical zone of interest of about 12 in (30 cm);
Measurement capabilities for other physical properties, such as total conductivity, gross gamma, gross alpha, dissolved oxygen, pH, and temperature; and
Remote operation with solar and/or battery power.

It is to be understood that the foregoing is a detailed description of certain embodiments. The scope of the present disclosure is not to be limited thereby and is to be measured by the claims, which shall embrace appropriate equivalents.

### EXAMPLE 1

### Test of Proportional Detector and Active Metal Gas Generator

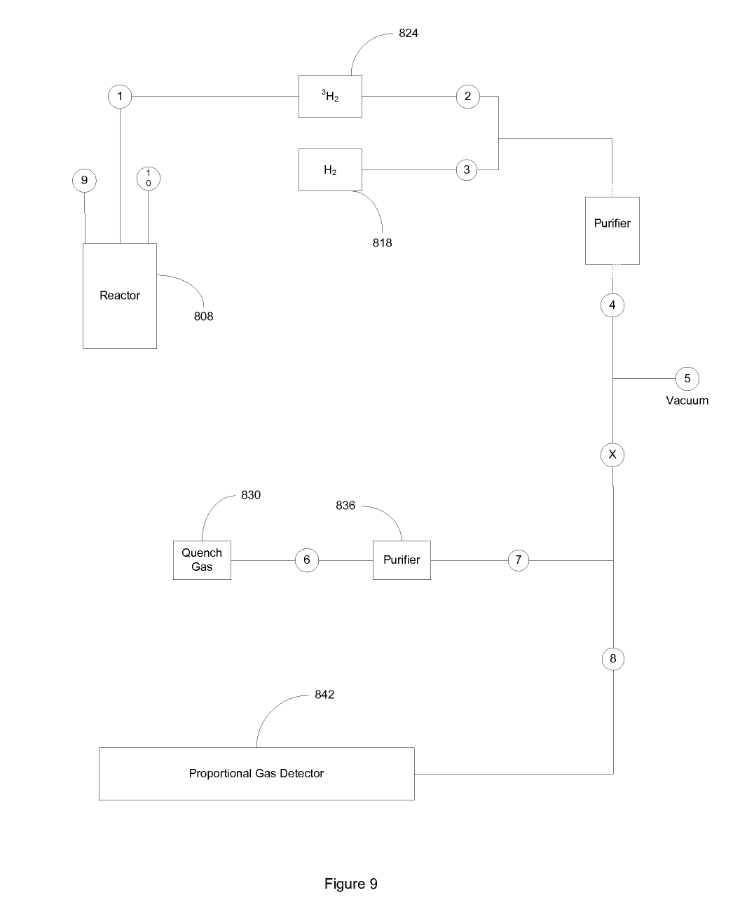

A diagram of a plumbing system useable in a tritium monitoring device is shown in FIG. 9. The system 900 is based on gasification of a water sample and proportional detection of tritium in the gas. The system 900 contains a reactor 908 for gasification of a tritiated water sample, a purifier 910 to remove water from the gas, a hydrogen source 918, at tritium source 924, a ¹³⁷Cs β source (not shown) for background calibration, a quench gas source 930 and purifier 936 used to maintain proportional conditions, and a proportional detector 942 to analyze the hydrogen and hydrogen-tritium gas samples. In the initial tests conducted with the system illustrated in FIG. 9, a custom detector was fabricated by Ludlum Measurements, Inc.

Hydrogen-Tritium Gas Generation

Hydrogen-tritium gas was prepared as follows. One liter of water containing 1,000,000 pCi of tritium was placed in a pressure reactor and the gas space was evacuated. A stirrer was activated, and 25-g of sodium metal was simultaneously dropped into the water. Hydrogen-tritium gas representative of the 1,000,000 pCi/L tritium concentration of the water was instantly produced in the reactor. The generated gas was transferred to a gas storage cylinder to provide a uniform source of hydrogen-tritium for use in this Example 1.

Proportional Detector

The initial Ludlum detector used in this Example 1 was 91.44 cm long and had an outer diameter of 4.45 cm. The detector was constructed using 3.18 mm thick wall 316 stainless steel pipe and had a volume of 1.3 L. Up to thirty-six 0.025 mm diameter stainless steel wires were arranged equidistant from one another and parallel to a central 6.35 mm outer diameter 304 stainless steel tube that was located on the center axis of the detector tube. The central tube serves as the ground potential electrode while the stainless wires served as the positively charged electrodes. The potential across the electrodes was variable up to approximately 2.7 kV.

Several tests were conducted with the proportional detector to quantify detector response as a function of: quench gas composition and mixture ratio, operating pressure, and applied voltage. The operating characteristics were varied to optimize the detector response for linearity within the tritium activity range of interest: 1,000 to 1,000,000 pCi/L.

Pressure in the proportional detector system was measured with a transducer accurate to ±2 percent full scale. The entire gas handling system was leak tested with a helium leak detector. Tests were conducted by evacuating the system with a mechanical vacuum pump for at least 20 minutes. After leak testing, hydrogen gas was admitted to a predetermined pressure. The amount of hydrogen-tritium required for the test was then admitted. Finally, quench gas, usually propane, was admitted. Most tests were conducted at 1.3 atm (0.13 MPa) total gas pressure, but the range of pressures examined was from 1.0 to 3.0 atm (0.10 to 0.30 MPa). This procedure enabled testing of the tritium monitor over the tritium concentration range in water of 0 pCi/L to 700,000 pCi/L. Counting tests to establish the basic shapes of the curves and the effects of variations in operating pressure or gas composition were of 1.0 min duration. Confirmatory tests lasted 10.0 min and the tests to develop the counts versus tritium concentration lasted 980.0 min.

Tests were originally conducted with the proportional detector positioned horizontally on the bench. Noticeable variations in the background were detected. Accordingly, subsequent tests were conducted with the proportional detector surrounded by 5.08 cm thick lead bricks. Surrounding the detector with lead bricks lowered the background detector response to the point of a constant value.

As quench gas, early tests used 95% pure commercial propane passed through a 200 mL Oxyclear™ cylinder from LABCLEAR, Oakland Calif., to remove water and oxygen, as these constituents can interfere with the accuracy of the proportional detector. Later tests used 99.97 percent pure propane that was also passed through the Oxyclear™ cylinder. A similar gas purification procedure was followed for the hydrogen and the hydrogen-tritium. The 99.97 percent purity hydrogen and the hydrogen-tritium was passed through a different 200 mL Oxyclear™ cylinder before entering the proportional detector. These purification procedures generated consistent test results. The scatter observed in the counts may be due to the random uncertainty of the radioactive decay.

With reference to FIG. 9 (where valves are indicated by circled numbers), the operational procedure for operating the instrument for these tests was:
All of the lines were evacuated by opening valves 4, 5, 7 and 8.
Valves 5 and 7 were closed.
Valve 3 was opened to allow hydrogen for background readings to flow through the purifier and into the proportional detector until the pressure was 1.0 atmosphere.
Valves 3, 4 and 8 were closed.
Valve 5 was opened to evacuate hydrogen from the lines.
Valve 5 was closed and valves 6, 7 and 8 were opened to allow quench gas (propane or methane) to pass through a purifier and into the proportional detector until the desired concentration was reached (quench gas concentrations of 20, 30 and 40 percent quench gas were studied).
Valves 6, 7 and 8 were closed, and a background radiation standardization curve of counts versus applied voltage was generated. Then a ¹³⁷Cs γ radiation source was placed on the surface of the detector midway from the ends. A curve for background plus the ¹³⁷Cs source was generated.
The proportional detector was evacuated by opening valves 5 and 8.

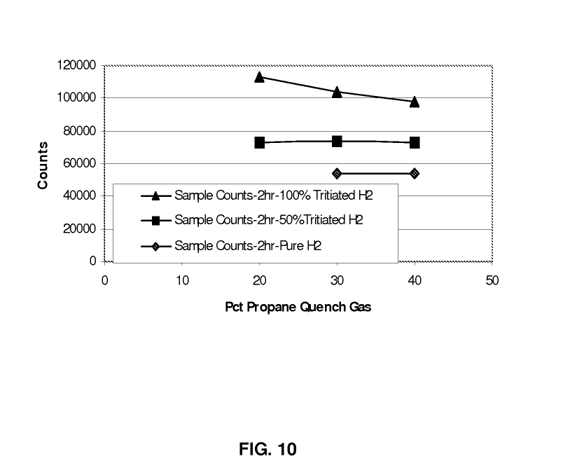

For developing the detector calibration functions using hydrogen/tritium, the above procedure was repeated but the hydrogen-tritium gas was used instead of pure hydrogen. The Ludlum detector results for a count-time of two hours are shown in FIG. 10. For 30 percent propane, the background count was 55,000 and the sample-plus-background count was 105,000. The standard deviation, σ, for this level is σ=(105,000)^{1/2}=324 counts. Recording a count of the background level plus a represents a 95 percent confidence level. Because subtracting 105,000 counts from the background represents 1,000,000 pCi/L, and the target detection limit is 1000 pCi/L, 1000 pCi/L yields (105,000−55,000)/1000=50 counts. Fifty counts is smaller than σ (324 counts), so the detector could discern about 6,500 pCi/L with 95 percent confidence.

These results were from early tests in which the detector was not shielded from background radiation, the test conditions were not optimized, and the counting time was relatively short. In actual use in a well, the background will likely be lower because of shielding by the earth. In addition, longer counting times can be used to lower the uncertainty in the background. These measures should enable detection of tritium at 1,000 pCi/L.

### EXAMPLE 2

### Bench Scale Instrument

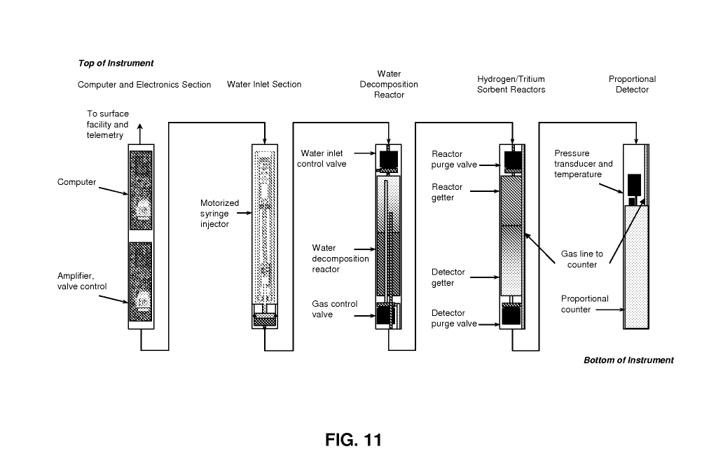

A radiation monitoring device, shown schematically in FIG. 11, was designed and built. This instrument was configured to sample water in a groundwater well or unsaturated zone borehole, gasify the water sample, count the decay of gaseous tritium, and remove hydrogen-tritium gas through a hydrogen sorbent reaction.

The sample was introduced into the instrument through a hand operated valve and syringe apparatus. The syringe forced water into a reactive metal reactor where it was gasified into hydrogen-tritium gas. This gas was then directed into a proportional detector for tritium analysis. When the analysis was complete, as determined by count statistics collected by the on-board computer, the gas was removed from the system by a hydrogen-tritium sorbent reactor, or ‘getter’.

The first instrument design included a sample collection-purging unit, a water decomposition reactor, a proportional detector, a hydrogen-tritium selective membrane and a hydrogen-tritium getter. However, the membrane was later replaced with a getter capable of sequestering the hydrogen-tritium gas in the presence of propane.

Water Decomposition Reactor

Initial tests were conducted in a Parr Instruments model 4561 autoclave. The diameter of the bomb portion was 6.35 cm i.d. with 6.35 mm thick walls. The bomb was 22.86 cm high. The head was equipped with six ports. The ports served the following purposes: admission of liquid NaK alloy, gas evacuation, water injection, pressure measurement, temperature measurement, and hydrogen-tritium gas outlet. Temperature measurement was made with a generic Omega chromel-alumel thermocouple. Pressure was measured with a generic Omega pressure gage with a range of 0 to 300 psig (0 to 2.07 MPa).

NaK alloy was added to the reactor by pressurizing the supply cylinder with argon and using the argon to push the liquid alloy into the reactor through 3.18 mm stainless steel tubing. The 454 g NaK supply cylinder was located on a top loading balance. The mass of NaK admitted to the reactor was determined by the change in mass of the supply cylinder after passage of the NaK from the cylinder into the reactor. This weighing system was shown by preliminary tests to be accurate to ±1 gram. Water was injected into the reactor with a standard 3 mL hypodermic syringe with a 22-gage needle. This injection method was found by gravimetric analysis to be accurate to ±0.1 mL.

The general operation of this reactor proceeded as follows. Air in the reactor was evacuated with a mechanical vacuum pump. After the air was removed, a valve in the NaK feed line was opened and NaK added until the supply cylinder had lost the number of grams required for the test. After the desired amount of NaK was added to the reactor, the NaK valve was closed. A valve between the hypodermic syringe and the reactor was opened and the plunger to the syringe was simultaneously pushed until the proper amount of water was injected. The NaK instantaneously reacted with the water sample. Constant pressure was exerted on the syringe plunger until the valve was closed.

Usually, sufficient NaK had been added to the reactor to conduct several tests, so the water injection procedure was repeated until the NaK was completely reacted. Upon exhaustion of the NaK, additional water was added to the reactor until all of the NaOH and KOH reaction products dissolved. The reactor head was then removed and the strong caustic solution poured out. The bomb and head were washed with water and dried before reassembling the reactor for the next test series.

Two additional reactors were constructed from stainless steel pipe fittings having diameters of 6.35 cm and 2.54 cm. These reactors demonstrated that a water sample could be reliably gasified and the gas drawn off for analysis.

Valves

Two types of valves were used in the instrument. Electrically operated solenoid valves were used for gas flow control. These valves were obtained commercially from Snap-Tite, Inc., and were either magnetically-latching or non-latching valves. Magnetically latching valves were used in locations requiring the valve to be opened for extended periods of time, whereas conventional non-latching types were used for quick acting applications. Magnetically latching valves were used on the getters, while a non-latching valve was used for the isolation valve.

Syringe

A motorized syringe made for the purpose of injecting tracer into a well was examined as a possible means to inject water into the reactor. Initial modifications were made to this syringe such that the stroke length could be readily changed, and the electronics were bypassed to allow direct communication between the controller and the syringe motor. Experiments were conducted with the syringe to evaluate the quality of the injectate stream during operation. The injectate stream must be of sufficient force to penetrate into the reactant pool in the reactor to promote a complete reaction.

Activated Carbon Sorption of Radon

Tests were conducted to determine the ability of activated carbon to remove radon from gaseous samples. A test apparatus was constructed which included a radon source, a hydrogen carrier gas source, an activated carbon sorption module, a hydrogen-radon collection container, and a scintillation counter. The radon source was a Pylon RN 150 unit, available from Pylon Electronics, Inc., of Mississauga, Ontario. A Ludlum Measurements, Inc. (Sweetwater, Tex.), Model 218 scintillation detector flask was used. A Ludlum Measurements Model 2200 scalar or a Ludlum Measurements Model 2000 scalar was used to record the counts. The scintillation chamber was a closed 8.89 cm by 10.16 cm high Plexiglas cylinder. Zinc sulfide scintillator paper lined the surface of the cylinder walls. The activated carbon module was a section of 0.95-cm o.d. stainless steel tubing. To vary the amount of carbon in the apparatus, the length of the carbon module was varied from 5.05 cm to 25.4 cm.

During each test, the system was evacuated with a mechanical vacuum pump for 30 minutes. After evacuation, radon was injected into the carrier gas. This gas mixture was metered into the evacuated gas collection system at a controlled rate. The gas passed through the activated carbon module and into the scintillation chamber. Gas flow was stopped when the pressure reached 1.0 atm (0.10 MPa) in the scintillation chamber. The activity of the gas in the scintillation chamber was measured immediately after its collection to detect the presence of daughter products that passed through the carbon. Counting time was 10 minutes. Counts were compared to counts for gas collected without the activated carbon module in place.

Hydrogen-Tritium Getter

Two types of getter materials were used. The first type was a metallic getter. The second type was a polymeric getter. The polymeric getter has platinum groups. Suitable polymeric getters are available from Sandia National Laboratories. One such class of materials is described in U.S. Pat. No. 7,001,535, incorporated by reference herein.

Propane or methane will typically poison metallic getters. However, it has been reported that polymeric getters remain effective in the presence of these gases. Metallic getters can typically be regenerated, while polymeric getters cannot typically be regenerated. Samples of each type of getter were obtained from Vacuum Energy Corporation and from SAES Getters USA, Inc. (Colorado Springs, Colo.), part number ST 198. The getters were placed in a test apparatus to determine their suitability for use in the radiation detection instrument.

The test apparatus for the hydrogen-propane getters used the proportional detector vessel as its gas source. The proportional detector was oriented either horizontally or vertically for these tests. Stainless steel tubing containing a pressure transducer passed from the detector up to a module containing the getter material. A second stainless steel tube returned purified quench gas to the proportional detector. Gas flow occurred due to the density difference between the hydrogen-propane feed (lighter) and the propane passed by the getter (denser). Hydrogen sorption, ‘gettering’, was monitored by the decrease in gas pressure. Tests were conducted at 1-3 atm (0.1-0.3-MPa) gas pressure. Variables studied during the tests included proportional detector orientation, piping size, propane concentration, and amount of getter. All tests were conducted at room temperature.

Assembled Test Radiation Monitoring Device

The components of the test version of the radiation monitoring instrument were machined, assembled and mounted onto a plywood panel. In certain embodiments of the test device, a motorized syringe is used in conjunction with the reactor solenoid valve to flush water from the lines and to inject a measured amount of water into the reactor. In certain tests, some of the components were mounted either on an adjacent lab bench or the floor to allow access to various instrument components. In further tests, rather than the computer controlled injector, a hand operated syringe was used to inject water into the reactor. The proportional detector was located within a cavity formed by lead bricks stacked such that a 10.16 cm square opening was maintained to the floor.

The reactor was machined from 0.32 cm wall, 316 stainless steel and was 78.74 cm long by 3.30 cm o.d. The head and the bottom screw into the tubing and were sealed with buna-n o-rings. In the reactor design used in this instrument, the hydrogen tritium gas passes through a riser tube and out the bottom of the reactor. The reactor was charged with NaK through the bottom. Water was injected through a 22-gage (0.027-cm) needle that passed through the head and into the base of the reactor solenoid valve located immediately above the reactor. A generic Omega pressure gage was plumbed into the gas line from the reactor to the detector to monitor the reactor pressure. Rather than the pressure gage, pressure transducers may be used to monitor the pressure. A chromel-alumel thermocouple monitored the reactor temperature.

Gas from the water decomposition reactor passed through a cylindrical 10.16 cm long by 3.56 cm o.d. activated carbon module made by Swagelok Co. (Solon Ohio), model 304-HDF2-40 to remove radon. Swagelok tubing connectors were screwed into each end. The internal volume was 75 mL, and the module held approximately 40-g of 48C12×30 activated coconut carbon obtained from Westates Vocarb Corporation (Siemens Water Technologies, Warrendale, Pa.). Even though radon was not used in these tests, the activated carbon module was included to study its effect on the hydrogen-tritium dynamics and the system hydrogen-tritium volume. From the activated carbon module, the sample gas passed into the proportional detector.

The proportional detector was a 91.44 cm long by 4.45 cm o.d. 316 stainless tube of 0.32 cm wall thickness. The bulkhead-style ends were sealed with o-rings and secured with screws that bear pull-out forces in shear. A high voltage feed through and a gas inlet-outlet passed through this bulkhead. A single 2.54×10⁻³ cm diameter, 316 stainless steel wire was located along the axis of the tube and functioned as the high voltage wire. A pressure transducer monitored pressure in the detector.

The getter module was 105.4 cm long by 3.30 cm o.d. with 0.32 cm thick walls. The head and the bottom screw into the tubing and were sealed with buna-n o-rings. A 0.64 cm gas inlet tube of 304 stainless steel was connected to the top and bottom of the getter. Cartridge filters were placed at each end of the getter pipe. Polymeric getter material was placed in a nylon sock and loaded into the getter pipe after emplacing the bottom filter. The top filter was then emplaced and the top screwed on. The detector pressure transducer, obtained from Omega monitored pressure drop during gettering.

On-Board Electronics Package

The test device was controlled using a controller 356, as described with respect to FIG. 3 above.

Bench Scale Instrument Experimental Methods

A series of tests was conducted using the test device, as summarized in Table 1. Testing was conducted as follows. Each subsystem was checked out individually, then groups of systems were checked, and finally as the entire monitor unit was checked. The unit was then operated under the range of conditions expected in the field to obtain statistics to verify its ability to detect tritium. In general, testing proceeded as follows:
The 5.08 cm diameter pipe containing the detector was shielded with lead bricks. The lead bricks simulated the shielding provided by the earth.
The system was leak tested with a helium leak detector prior to operation.
Known tritium concentration hydrogen-tritium gas samples were placed in the bench detector and readings made.
Multiple analyses were made of a blank hydrogen sample to determine the precision of the detector.
Operation of the bench reactor was tested with a blank water sample.
Multiple decompositions were made of a blank water sample. Each gas sample was analyzed in the detector to determine the precision of the decomposition-detector combination.
Known tritium concentration water samples were injected into the reactor and the hydrogen-tritium gas was analyzed in the detector.

The proportional detector was operated for 16-hour count times with known concentrations of hydrogen-tritium gas over the concentration range 0 to 682,000 pCi/L to establish a standardized curve of counts versus tritium concentration. The statistical uncertainty of radioactive decay was determined from this curve. The lower limit of detection was the point where the increase in counts above background equaled the statistical uncertainty.

Water samples having known tritium concentrations were decomposed and analyzed. The results were plotted on the same page as the standard curve generated by analysis of gas of known hydrogen-tritium concentration. Accuracy was determined by taking the difference of the measured value for known tritium in water concentrations from the known tritium in hydrogen-tritium gas curve followed by dividing the obtained value by the known gas concentration value and multiplying by 100. This value should be less than ±10 percent of the standardized value.

The standard deviation of the set of five determinations made in the accuracy determination experiments was a measure of the sensitivity. A measurement within two standard deviations was taken as being within the 92 percent confidence limit; a measurement within one standard deviation was within the 95 percent confidence limit.

Test Device Results

Table 1 summarizes the types of test conducted, their purpose, and the number of each test conducted using the test device.

TABLE 1
Test and evaluation series that were
completed with the TEST DEVICE

| | | Number |
|---|---|---|
| Type of Test | Purpose | of tests |
| Physical Testing | Check for leaks & operational | 1 |
| | problems | |
| Generate Standardization | Develop room temperature curve | 6 |
| Curve | for tritium concentration | |
| | determinations | |
| Background Determinations | Determine room temperature back- | 3 |
| | ground counts | |
| Tritium Concentrations | Determine room temperature | 3 |
| | tritium | |
| Determinations | concentration and accuracy over | |
| | a range of concentrations | |
| Precision Determinations | Determine statistical variation | 8 |
| | of background reading using | |
| | blank sample | |

Water Decomposition Reactor

One object of the water decomposition reactor tests was to determine if the NaOH and KOH reaction products would sink to the bottom of the liquid NaK alloy pool so that the succeeding water samples would contact fresh NaK alloy and completely react. Another object was to establish that there would be no reaction of the hydrogen-tritium with the NaK alloy. Once the operability of the reactor was confirmed, reactor conditions were optimized, such as by determining the amount of NaK alloy required per gram of water, heat of reaction effects, the best way to inject the sample, and how much unreacted NaK alloy remained in the reaction product layer.

Preliminary tests were conducted in the 6.35 cm Parr reactor because it had sufficient ports for all of the needs of the tests and was robust, in case unusual temperatures or pressures occurred in the testing.

Initial reactor tests employed only 6 g of NaK alloy to minimize potential problems. These tests established that the reaction of water with NaK alloy worked as predicted by the chemical equations. Reaction was virtually instantaneous and nearly complete. However, some unreacted NaK alloy remained in the hydroxide product layer.

To study a reactor suitably sized for a 5.08 cm diameter borehole, smaller reactors than the 6.35 cm Parr were used in subsequent tests. The initial test in the smaller diameter reactor used a 2.0 mL aliquot of water injected through a syringe into a 3.18 mm feed pipe that directed the water into the NaK alloy pool. The reactor contained 19 g of alloy. Pressure and temperature were monitored with a pressure transducer and a thermocouple. The hydrogen was evacuated from the reactor after each water injection. The reactor contents were allowed to cool before subsequent water injections. The test results are shown in Table 2.

TABLE 2
Hydrogen pressure and temperature per 2-mL water injection.

| Injection | Pressure Rise, | Instantaneous |
|---|---|---|
| No. | psig (MPa) | Temperature Rise, ° C. |
| 1 | 18 (0.12) | 88 |
| 2 | 45 (0.31) | 380 |
| 3 | 37 (0.26) | 355 |
| 4 | 43 (0.30) | 416 |
| 5 | 23 (0.16) | 184 |
| 6 | 25 (0.17) | 255 |
| 7 | 0 | 0 |

The variation in the pressure and temperature rises indicated that the water was not completely reacting with the NaK alloy. The high temperatures noted were transient and quickly subsided to the range of 30-40° C. Further water injection tests indicated that when reaction was incomplete, water was retained within a hydroxide coating. The completeness of the reaction decreased when the water drop size was large and increased when the drop size was small. Hypodermic needles of various sizes were tested and it was found that a size of 22-gage (0.027-cm) needle injector was small enough to consistently produce complete reaction.

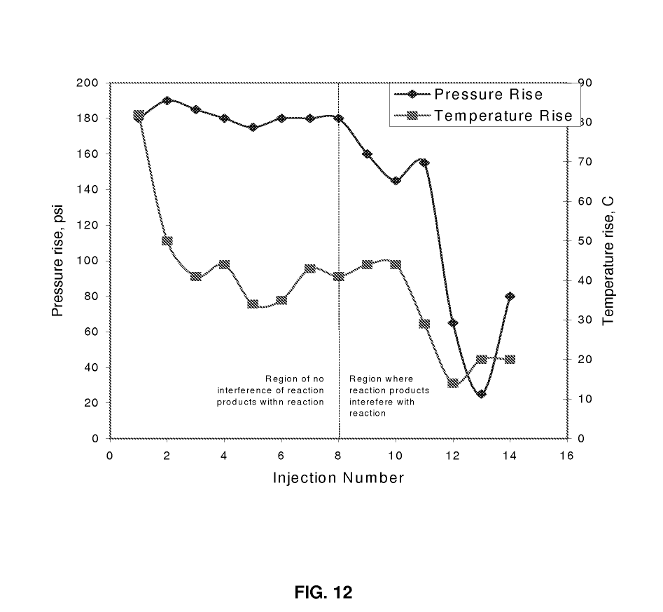

Results for a representative test using 37-g of NaK alloy with the 22-gage (0.027-cm) needle are shown in FIG. 12. The pressures are much higher in FIG. 12 than in Table 2 because the gas-space of the reactor was reduced to investigate operation of the reactor at higher pressures. Also, the amount of water injected was reduced to the size aliquot needed to generate the proper amount of gas for the proportional detector. The temperatures were lower because the thermocouple was relocated to the outside of the reactor from the liquid alloy pool.

The results shown graphically in FIG. 12 demonstrate what happens inside the reactor with successive injections of water. Water aliquot usage and reaction consistency were excellent for the first 8 injections. Then a pattern of decreasing reaction was observed. Temperature decreases after injection 8. These data indicate that the hydroxide reaction products are interfering with the reaction after injection 8. In other words, there is no longer a pool of liquid alloy available for reaction with the water. The percent of alloy available for complete reaction with the water was calculated by adding the first 8 pressure aliquots, multiplying by 100 and dividing by the sum of all of the pressure aliquots. The sum of the pressures from the first 8 aliquots is 1450 psig (10.0-MPa); the sum of all of the aliquot pressures is 2080 psig (14.3-MPa). Percent available alloy=(1450×100)/2080=70 percent. This calculation indicates that complete reaction will occur as long as at least 70 percent of the alloy remains. Therefore, the reactor should carry 1.0/0.7=1.3 times the theoretical amount of alloy required for reaction to insure that complete reaction will occur with a given number of tests.

Another consideration in reactor design and operation is whether the depth of the NaK alloy pool negatively affects the usage factor and the completeness of reactions. A test using 115 g of alloy (22.86 cm pool depth) showed 80 percent NaK alloy use before complete water reaction was no longer observed. As a result of this test, and tests using smaller quantities of NaK alloy, a somewhat conservative usage factor of 70 percent was chosen for the design calculations.

The reactor was also studied to see whether reaction was occurring between the hydrogen-tritium product and NaK alloy. The reactor was charged with NaK alloy and then pressurized with hydrogen. The reactor was wrapped with heat tape and heated to 60° C., which is the temperature that is achieved due to the heat of reaction. Pressure was monitored over three hours. A drop in the pressure would indicate that a reaction was occurring between the hydrogen and the NaK alloy according to the reaction:

H₂+NaK→NaH+KH

No pressure drop was observed, indicating that there was no reaction between the hydrogen and the NaK alloy.

However, it was discovered that an unknown reaction occurs between the propane quench gas and the NaK. The proportional detector side of the instrument was isolated from the water decomposition reactor using an isolation valve. Two pressure transducers may be installed to monitor the pressure differential between the detector and the water decomposition reactor to allow computer control of the isolation valve.

Proportional Detector

The initial instrument experiments were conducted with the Ludlum detector. However, subsequent work employed custom designed and fabricated detectors. Two versions of a 1 L volume detector were designed and fabricated that met the diametrical specification necessary for a 4.45 cm overall diameter instrument package. These versions included a six-wire detector and a single-wire detector. Successive iterations on design and fabrication techniques led to increasingly higher performing detectors, and formed the basis for the field deployable 0.5 L detector design. One such device is shown in FIG. 6.

There was an effort to remove radon from the hydrogen-tritium gas stream prior to admission to the detector, radon is likely to be present in many testing conditions. A carbon-strip reactor was tested and found to be successful in removing radon. However, the addition of the carbon-strip reactor has the potential drawback of adding gas volume to the instrument, which in turn may indicate using a greater volume of hydrogen sorbent, additional NaK reserve, etc.

Because radon has a relatively short half-life of 3.8 days, it is possible to allow radon to naturally decay in the water decomposition reactor if the tritium activity sampling frequency is monthly, or quarterly. In addition, the proportional detector and associated amplifier and counter electronics are capable of discriminating between radon and tritium decay. These three methodologies are expected to adequately provide a means of removing or quantifying radon to permit an accurate quantification of tritium activity.

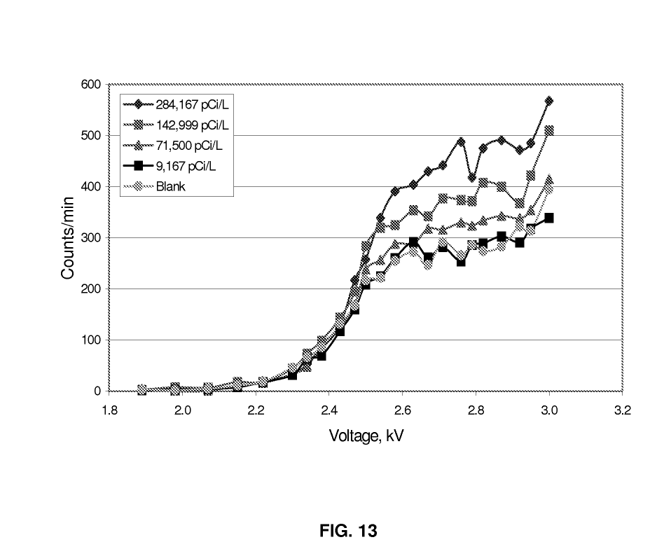

Tests were conducted to develop a plot of counts vs. tritium concentration to 280,000 pCi/L with the lead shielded proportional detector. Several tritium concentrations, prepared by diluting 770,000 pCi/L hydrogen-tritium with hydrogen, as well as a blank composed entirely of hydrogen, were mixed with propane to a concentration of 67 percent hydrogen-tritium and 33 percent propane. When the sample was in the detector, the voltage was ramped from 1.89 kV to 3.00 kV in increments of about 0.05 kV. Each voltage was held for 2 minutes and the counts recorded. FIG. 13 illustrates plots of counts averaged to 1 minute versus voltage prepared from this data.

The resulting curves were all of the same basic shape, beginning from a low plateau from 1.9 kV to about 2.3 kV. The curve then rises steeply to about 2.5 to 2.6 kV. The curve then flattens out until about 2.9 kV at which point it rises steeply again. The first portion from 2.1 to 2.5 kV represents the proportional range and the region from about 2.6 to 2.9 kV represents the Geiger Müller (GM) range.

The response and calibration of the proportional detector at a fixed applied voltage was undertaken with tritiated water obtained from the Nevada Test Site ‘E-tunnel’ by reacting this water in either a commercial laboratory hydrogen generation system (Phase 1) and by generating hydrogen-tritium gas with this water using the test version of the instrument water decomposition reactor (Phase 2).

The Phase 1 test protocol for the proportional detector consisted of:
Placing known tritium concentration hydrogen-tritium gas in the detector. The hydrogen-tritium gas was generated by reacting sodium metal with a Nevada Test Site E-Tunnel water sample in a commercial hydrogen generator. This sample contained 820,000 pCi/L of tritium at the time of sampling.
Diluting the hydrogen-tritium gas with purified hydrogen gas to the concentration to be tested.
Adding propane in the ratio of 1 volume propane to 2 volumes of the diluted hydrogen-tritium.
All tests were conducted at 1.5 atm total pressure and room temperature.

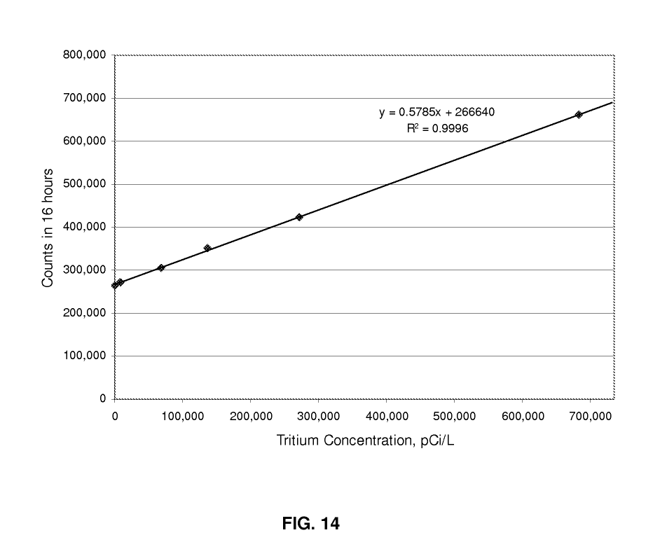

Counting at several tritium concentrations for 16-hours produced the following curve of counts vs tritium concentration, shown in FIG. 14. The curve is linear over the range of concentrations measured and has a slope of 0.5785 times the tritium concentration. At 1000 pCi/L, after 16-hours of counting, there would be 578.5 counts above background. This number of counts is greater than the statistical uncertainty in the background of 518.5 counts, indicating that the detector is sensitive to less than 1000 pCi/L tritium concentration.

An assessment of detector precision was also conducted. Five determinations of the blank were made. Counting for each determination lasted 16-hours. The results are shown in Table 3.

TABLE 3
Detector tests using a blank hydrogen gas sample to determine
background characteristics of the detector.

| Run No. | Counts in 16 Hrs |
|---|---|
| 1 | 259,233 |
| 2 | 259,613 |
| 3 | 258,550 |
| 4 | 258,241 |
| 5 | 258,799 |
| Sum | 1,294,436 |
| Average | 258,887 |
| Standard Deviation | 544 |

The standard deviation is a measure of the precision of the data. The standard deviation of 544 counts in 16 hours for the blank gas sample compares well with the statistical variation of 518.5 counts in the background radiation measurement of the detector. The slightly higher uncertainty in the precision of the blank was likely to due fluctuations in the system, including small variations in voltage, pressure, gas composition, temperature and capture of counts during the 16 hours of counting. These data show that the readings made by the proportional detector are still precise enough to discern 1000 pCi/L tritium concentration.

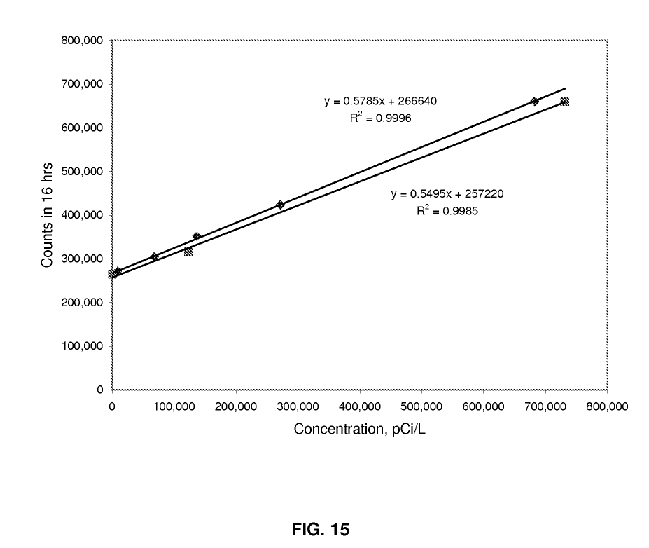

The Phase 2 test protocol for the proportional detector consisted of the following steps:
An aliquot of Nevada Test Site E-tunnel water was diluted into several known lower tritium concentrations for injection into the bench water decomposition reactor.
Each water decomposition test was conducted with 2.5 mL of sample water. This amount of sample produced about 1500 mL (at standard temperature and pressure, STP) of hydrogen-tritium gas at 85 psig in the reactor. The hydrogen-tritium gas remained in the reactor to allow the pool of sodium-potassium alloy in the reactor to react with and remove any traces of moisture from the gas. These tests demonstrated that 30 minutes was sufficient for moisture removal.
After reaction, the hydrogen-tritium gas was rapidly metered into the detector. The detector was precharged with 333 mL (STP) of propane quench gas. The hydrogen-tritium and propane were allowed to mix for a sufficient time to allow for complete mixing, about 60 minutes.
The voltage was set at 2.70 kV and tritium decay was counted for 16 hours. A curve of counts from three known tritium-in-water concentrations was plotted along with the curve produced from known tritium concentrations in hydrogen-tritium gas as shown in FIG. 15.

The two linear regressions exhibit similar slopes. However, the data generated with the test water decomposition reactor has a slightly smaller y-intercept than the data generated with hydrogen-tritium gas made with the commercial reactor. The difference was about 5 percent. This difference may be attributed to a small amount of water from each decomposition reaction not reacting and remaining entrained in the NaK pool in the test reactor. This water appears to decompose during subsequent decomposition reactions.

The three water decomposition reactions that define the curve were made in the order of low to high tritium concentration. Consequently, the measured activity for each of these analyses would be expected to be slightly lower than expected and is demonstrated by the lower slope of the linear regression for the bench reactor data. When analyzing a sample lower in activity than the preceding sample (results not shown), the proportional detector produced an apparent activity that was slightly higher than expected as a result of ‘carry-over’ of a small volume of higher activity water.

A check of the precision of the results from the combined water decomposition-analysis train was made by decomposing three blank water samples. The counts were 264,798; 264,782; and 262,505 counts in 16-hours of counting respectively. These results are consistent with similar tests conducted using known hydrogen-tritium gas compositions.

Hydrogen Getter Reactor Tests

Two different types of hydrogen sorbent, or ‘getter’ material were tested for use in the tritium monitoring instrument. Both types of material are commercially available, and represent hydrogen sorbents that would be suitable for an in situ monitoring instrument application.

Polymeric Getter

Sandia National Laboratory has developed polymeric getters for hydrogen adsorption. Three different polymeric getter compositions were obtained and tested. The first getter composition tested had a capacity of 100 mL of hydrogen per g of getter. In initial tests the first getter composition removed hydrogen from the detector at an operationally acceptable rate. The getter loaded to the advertised capacity.

The second getter composition had a capacity of 150 mL/g and a much faster hydrogen sorption rate. This getter composition removed the hydrogen over twice as fast as the first getter composition, and had higher sorption capacity. However, following exposure to hydrogen this second getter formulation formed a ‘cake’ or cementious mass that made it difficult to remove from the reactor. The formation of a cementious mass during sorption may lead to lower gas permeability of the getter material, thereby increasing the time required to remove hydrogen from the instrument. The first getter composition also formed a cementious mass. The third getter composition had a sorption capacity of 160 mL H₂/g, adsorbed hydrogen at an acceptable rate, and the spent getter was easily removed from the container with no apparent cementious behavior. Because of this success, the third getter composition was used for all subsequent tests.

Getter tests with the hydrogen-propane mixture demonstrated that hydrogen could be selectively removed from the gas mixture and that propane had no adverse effects on the getter. Getter tests were also performed with a hydrogen-methane gas mixture. These tests demonstrated that separating hydrogen from methane required nearly twice as much time as separating hydrogen from propane. The greater density of propane may be responsible for the greater ease of separating hydrogen from propane compared to separating hydrogen from methane.

A getter container was designed that measured 101.6 cm long by 2.86 cm inside diameter. This getter container can house enough polymeric getter for 30 in situ tests, assuming that 1 L of hydrogen-tritium gas would be removed from the detector and 0.6 L of hydrogen-tritium gas would be removed from the reactor for each test. In this design, the getter container was located directly above the detector. A 0.64 cm o.d. tube extended from the top of the detector to the top of the getter container. The getter container was filled with 100 g of getter, and the gas inlet and outlet were tightly packed with 5.08 cm of filter material to prevent loss of polymeric getter from the container. A series of getter tests was completed with this getter, and the results are shown in Table 4. For these tests, 0.5 atm of propane was added to the detector and the getter container. For each test, 1 L of hydrogen was added to the detector, which brought the detector to a pressure of 1.5 atm.

In tests 4-7, the 0.64 cm o.d. gas transfer tubes were replaced with 0.32 cm o.d. tubes to determine the effect of delivery tube size on the hydrogen removal rate. The smaller diameter tubes increased the hydrogen removal time by about 3 hr. The 0.32 cm o.d. tubes are advantageous since space can be limited within the in situ radiation detector pressure housing.

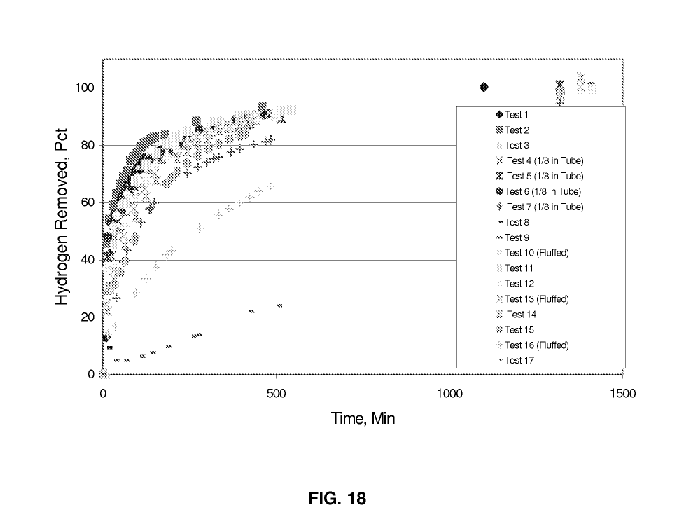

In tests 10 and 16 the normal gas flow direction was reversed for a short time. Under normal conditions, the valves between the detector and the getter were opened simultaneously. At the time the valves were opened, there was a large pressure differential between the detector and the getter chambers. As a result, gas rapidly flowed from the detector to the getter to equalize the pressure difference. In tests 10 and 16, only the valve on the return tube was opened during the gas surge. The concept of this operational change was to mechanically disturb the getter sorbent to try and prevent it from becoming consolidated to the point that gas flow would be subsequently restricted. In test 10, it appears from the data that there was an increase in the hydrogen removal rate as a result of this mechanical agitation. However, in test 16, no positive effect on gas flow rate through the bed was observed. The times at which 50 and 90 percent of the hydrogen was removed from the detector are shown in Table 4, and a plot of time versus temperature is shown in FIG. 18.

TABLE 4
Results of the polymeric getter tests.

| Time, | 1 | 2 | 3 | 4* | 5* | 6* | 7* | 8 | 9 | 10# | 11 | 12 | 13 | 14 | 15 | 16# | 17 |
|---|---|---|---|---|---|---|---|---|---|---|---|---|---|---|---|---|---|
| 50%, min | 20 | 15 | 10 | 20 | 25 | 15 | 20 | 30 | 45 | 20 | 40 | 55 | 60 | 75 | 120 | 190 | 24 hr |
| 90%, hr | 3 | 3.5 | 4 | 5.5 | 6 | 5.5 | 7 | 4 | 5.5 | 4.5 | 4.5 | 5.5 | 5.5 | 6 | 6.75 | 16 | |

*⅛ inch OD tubing for the feed line to the getter in these tests
#Fluffed the bed

The 90 percent hydrogen removal point was chosen as the point at which a new tritium detection test could begin in actual in situ tests. The data in the table show that through test 15, 90 percent of the hydrogen was removed in less than 7 hr.

Metallic Getters

Metallic getters generally have advantages over polymeric getters, including lower cost, higher hydrogen storage per unit volume, and reusability. However, organic gases such as propane typically poison metallic getters. For this reason, it was expected that a metallic getter would be used only to getter hydrogen from the reactor portion of the instrument. Since it is possible to employ separate getters for the reactor and the detector portions of the instrument, metallic getter compositions were evaluated.

The apparatus for these tests was similar to the apparatus used for the polymeric tests. A zirconium-nickel alloy was selected for these tests. The results of the tests demonstrated that the metallic getter removed essentially all the hydrogen from the reactor in a few hours. The rate of hydrogen removal with the metallic getter was somewhat slower than the rate measured with the polymeric getter, but the difference, which was on the order of 30 percent, is expected to be of no significance under normal operating conditions.

### EXAMPLE 3

### Field Instrument

The field deployable instrument was capable of sampling the borehole ten times before requiring extraction and servicing. A sample capacity of ten is suitable for an initial deployment where multiple sequential samples will be taken, and is also suitable for an extended deployment, sampling every five weeks or so for a period of one year. The instrument is scaleable to the needs of the end user as its sample capacity can be adjusted with relative ease.

The computer was placed at the top of the instrument to facilitate electrical connection with the geophysical wireline that serves as both the means to hang the instrument in the borehole, and to establish two-way communication with a surface-mounted computer and rf-communications equipment. The detector was placed immediately below the computer to minimize the length of coaxial wire required to connect the detector to the high voltage power supply. This design improvement allowed the use of a much larger diameter wire (lower noise, higher voltage rating) while eliminating the need to pass the high voltage wire between the detector and the high pressure instrument housing. Custom electronics packages were designed for the latching solenoid power supply, detector power supply, motorized syringe and high pressure valve power supplies, and detector signal conditioning. The on-board computer was an off-the-shelf Campbell Scientific Instruments (CSI) CR-1000 datalogger. Though the datalogger did not have the physical dimensional requirements to fit in a 4.45 cm o.d. package, it can be designed into a smaller diameter housing.

The detector was constructed as shown in FIG. 6. The detector was fabricated out of 316 stainless steel tubing and billet, high density machineable ceramic for electrical insulators, and 2.54×10⁻³ cm diameter high tensile stainless wire for electrode material. An off-the-shelf 10 kV rated high pressure electrical coaxial feed through serves as the means to connect the detector to the custom designed and fabricated power supply and signal conditioning components of the onboard computer system.

The instrument was based on a detector gas volume of 0.5 L as compared to the 1.0 L Ludlum detector. Because the instrument was designed to be deployed in an NTS well with a tritium activity approaching 200,000 pCi/L, the sensitivity of the 1.0 L laboratory detector design is not necessary, and a 0.5 L detector design reduced the overall length of the instrument. The length savings is a direct result of the scalability of the instrument since the water decomposition reactor and hydrogen getters are scaled to the volume of the detector. The detector was constructed with several electrodes arranged in a radial arrangement. The 0.5 L gas volume detector was expected to perform with a detection limit of 2,000 pCi/L and a sensitivity of ±5 percent at this activity level.

The getter reactor was split into two separate vessels, as it may be beneficial to isolate the metal alloy from the detector quench gas through an isolation valve. One getter was located immediately below the detector to adsorb hydrogen-tritium gas from the detector and associated plumbing down to the isolation valve. A separate reactor was located below the isolation valve and above the syringe injector to adsorb hydrogen-tritium gas from the reactor and associated plumbing up to the isolation valve. The hydrogen-tritium getter reactors were fabricated out of 316 stainless steel tubing and billet and incorporated magnetically latching electrical solenoid valves to control gas flow. The solenoid valves were operated by the on-board computer in conjunction with pressure transducers that allowed the computer to monitor gas pressure.

The water decomposition reactor was fabricated according to the design of FIG. 4 out of stainless steel tubing and billet, and incorporated a double buna-n© o-ring seal design with a mechanical lock system that has a calculated burst pressure in excess of 1,700 psig with an expected peak reaction pressure of 75 psig.

The high pressure valve mechanism of FIG. 5 was used, as it can withstand a pressure specification of 1,800 psig and an instrument diameter specification of 1.75 inches. Many solenoid valves are pressure rated for 125 psig or less. A rotary valve was designed and fabricated using a high performance liquid chromatography switching valve and a high performance motor and gearhead coupled through an adjustable slip clutch, as shown in FIG. 6 and previously described.

The rotary valve switches flow from the borehole to the mechanical syringe and between the mechanical syringe and the water decomposition reactor. The mechanical syringe uses a motor-gearhead combination that is similar to that of the rotary valve. The mechanical syringe was modified to include an adjustable stroke, and was controlled with two limit switches used in conjunction with the on-board computer to inject borehole water into the water decomposition reactor. The adjustable stroke modification allowed for ‘tuning’ the volume of water injected into the water decomposition reactor to achieve a desired hydrogen-tritium gas pressure.

We claim:

1. A radiation monitoring apparatus comprising:
a sample reactor comprising a reactive metal alloy;
a sampling device in fluid communication with the sample reactor; and
a detector in fluid communication with the sample reactor.

2. The radiation monitoring apparatus of claim 1, wherein the detector comprises a proportional detector.

3. The radiation monitoring apparatus of claim 1, further comprising a hydrogen getter reactor in fluid communication with at least one of the detector and the sample reactor.

4. The radiation monitoring apparatus of claim 1, further comprising a first hydrogen getter reactor in fluid communication with the sample reactor and a second hydrogen getter reactor in fluid communication with the detector.

5. The radiation monitoring apparatus of claim 1, wherein the reactive metal alloy comprises NaK.

6. The radiation monitoring apparatus of claim 1, further comprising an isolation valve intermediate the detector and sample reactor.

7. The radiation monitoring apparatus of claim 1, wherein the sampling device comprises a motorized syringe.

8. The radiation monitoring apparatus of claim 1, wherein the sampling device comprises a free piston hydraulic pump.

9. The radiation monitoring apparatus of claim 1, the sample reactor further comprising a sample injector, a gas outlet, and a baffle disposed over the gas outlet.

10. The radiation monitoring apparatus of claim 9, wherein the baffle is disposed over at least a portion of the sample injector.

11. A radiation monitoring apparatus comprising:
a hydrogen getter reactor comprising a quantity of hydrogen getter material; and
a detector in fluid communication with the hydrogen getter reactor and a sample source.

12. The radiation monitoring apparatus of claim 11, wherein the sample source comprises a water decomposition reactor.

16. The radiation monitoring apparatus of claim 12, wherein the sample source is in fluid communication with the water decomposition reactor.

17. The radiation monitoring apparatus of claim 12, wherein the hydrogen getter reactor is a first hydrogen getter reactor, further comprising a second hydrogen getter reactor in fluid communication with the water decomposition reactor.

18. A tritium measurement method comprising:
obtaining an aqueous sample;
in a monitoring apparatus, decomposing the aqueous sample into sample gas, the sample gas comprising hydrogen and tritium gas;
measuring the amount of tritium in the sample gas; and
removing the hydrogen and tritium gas from the monitoring apparatus.

19. The method of claim 18, wherein decomposing the aqueous sample into hydrogen and tritium gas comprises reacting the sample with a reactive metal alloy.

20. The method of claim 18, wherein removing the hydrogen and tritium gas from the monitoring apparatus comprises absorbing the hydrogen and tritium with a hydrogen getter material.

21. The method of claim 18, further comprises repeating the method a plurality of times without removing the instrument from a down hole monitoring environment.
